(19) United States
(12) Patent Application Publication
(10) Pub. No.: US 2024/0324834 A1
(43) Pub. Date: Oct. 3, 2024

(54) VACUUM PRE-SEPARATION DEVICE AND ACCESSORIES

(71) Applicant: MILWAUKEE ELECTRIC TOOL CORPORATION, Brookfield, WI (US)

(72) Inventors: Nathan Beining, Milwaukee, WI (US); Benjamin M. Teske, Milwaukee, WI (US); Sameer Sahu, Brookfield, WI (US); Ruslan Budnik, Milwaukee, WI (US); Nicole L. Fujimoto, New Berlin, WI (US); Timothy J. Campbell, Brookfield, WI (US); John Rymsza, Wauwatosa, WI (US); Manas M. Mahaddalkar, Milwaukee, WI (US)

(21) Appl. No.: 18/622,272

(22) Filed: Mar. 29, 2024

Related U.S. Application Data
(60) Provisional application No. 63/602,972, filed on Nov. 27, 2023.
(60) Provisional application No. 63/455,429, filed on Mar. 29, 2023.

(51) Int. Cl. A47L 9/16; A47L 5/14; A47L 5/36; A47L 9/14; A47L 9/20; B01D 45/16; B01D 46/681; B01D 50/20

(52) U.S. Cl. CPC A47L 9/1666; A47L 5/14; A47L 5/365; A47L 9/14; A47L 9/1608; A47L 9/165; A47L 9/1691; A47L 9/20; B01D 45/16; B01D 46/681; B01D 50/20; B01D 2279/55

(57) ABSTRACT

A vacuum pre-separation device for use with a vacuum assembly having a power head and a collection container. The pre-separation device including a housing defining a housing volume, where the housing includes a first connection interface configured to attach to the power head and a second connection interface configured to attach to the collection container, a cyclonic separator at least partially positioned within the housing volume, where the cyclonic separator includes a discharge port open to the second connection interface, and a feed passage configured to direct air into the cyclonic separator, where a first end of the feed passage is open to the first connection interface.

### CROSS-REFERENCE TO RELATED APPLICATIONS

The present application is a formalization of U.S. Provisional Patent Application No. 63/455,429, filed Mar. 29, 2023, and U.S. Provisional Patent Application No. 63/602,972, filed Nov. 27, 2023. The contents of both are hereby incorporated by reference.

### FIELD

The present disclosure relates generally to vacuum cleaners, and more specifically to accessories for use with vacuum cleaners.

### BACKGROUND

Traditional wet/dry vacuum designs utilize a container to collect debris and a separate power head that can be attached to the container to generate the necessary airflow the vacuuming operations.

In one instance, a vacuum pre-separation device for use with a vacuum assembly having a power head and a collection container, the pre-separation device including a housing defining a housing volume, where the housing includes a first connection interface configured to attach to the power head and a second connection interface configured to attach to the collection container, a cyclonic separator at least partially positioned within the housing volume, where the cyclonic separator includes a discharge port open to the second connection interface, and a feed passage configured to direct air into the cyclonic separator, where a first end of the feed passage is open to the first connection interface.

Alternatively or additionally, in any combination, where the first connection interface encloses a first connection region, where the first end of the feed passage is positioned within the first connection region.

Alternatively or additionally, in any combination, where the first connection interface and the second connection interface are positioned on opposite sides of the housing.

Alternatively or additionally, in any combination, where the cyclonic separator includes an exit aperture, and wherein the exit aperture is in fluid communication with the first connection interface.

Alternatively or additionally, in any combination, further including a filter casing sized to receive at least a portion of an air filter therein, and where the pre-separation device further includes an intermediate passage extending between the exit aperture and the filter casing.

Alternatively or additionally, in any combination, further including a filter casing sized to receive at least a portion of an air filter therein, and where the filter casing is open to the first connection interface.

Alternatively or additionally, in any combination, where the first connection interface encloses a first connection region, where the filter casing includes an open end, and where the open end is positioned within the first connection region.

Alternatively or additionally, in any combination, further including a first set of connection implements configured to selectively couple the housing to the collection container.

Alternatively or additionally, in any combination, further including a second set of connection implements configured to selectively couple the housing to the power head.

Alternatively or additionally, in any combination, where the housing includes a perimeter wall at least partially encompassing the housing volume, where the perimeter wall includes a first end and a second end opposite the first end, where the first end defines the first mounting interface, and where the second end defines the second mounting interface.

In another aspect, a vacuum assembly including a power head, where the power head includes a first housing at least partially defining a power head volume, a blower assembly at least partially positioned within the power head volume, a collection container at least partially defining a collection volume, and a pre-separator unit, where the pre-separator includes a second housing at least partially defining a pre-separator volume, a cyclonic separator at least partially positioned within the pre-separator volume, and a first flow path extending between the cyclonic separator and the blower assembly, and where the first flow path is always positioned within at least one of the power head volume and the pre-separator volume.

Alternatively or additionally, in any combination, where the power head further includes an inlet port open to the exterior of the first housing, the vacuum assembly further comprising a second flow path extending between the inlet port and the cyclonic separator, where the second flow path is always positioned within at least one of the first power head volume and the pre-separator volume.

Alternatively or additionally, in any combination, where the cyclonic separator includes a discharge port, and where the discharge port is in fluid communication with the collection volume.

Alternatively or additionally, in any combination, further including a debris flow path extending between the discharge port and the collection volume, and where the debris flow path is always positioned within at least one of the pre-separator volume and the collection volume.

Alternatively or additionally, in any combination, where the first flow path passes through a filter.

In another aspect, a vacuum assembly including a power head including a first housing at least partially defining a power head volume, where the first housing defines a first connection interface including a first internal connection region, and a blower assembly at least partially positioned within the power head volume, and a pre-separator unit including a second housing at least partially defining a pre-separator volume, where the second housing defines a second connection interface including a second connection region, and a cyclonic separator at least partially positioned within the pre-separator volume, and a first flow path extending between the cyclonic separator and the blower assembly, and where the first flow path passes through both the first internal connection region and the second internal connection region.

Alternatively or additionally, in any combination, where the power head also includes an inlet port that is open to the outside of the first housing, the vacuum assembly further comprising a second flow path extending between the inlet port and the cyclonic separator, and where the second flow path passes through both the first internal connection region and the second internal connection region.

Alternatively or additionally, in any combination, where the pre-separator unit includes a filter casing configured to contain a filter therein, and where the filter is attached to the power head.

Alternatively or additionally, in any combination, where the first flow path passes through a filter.

Alternatively or additionally, in any combination, where the first connection interface interacts with the second connection interface to relatively align the power head with the pre-separator unit.

In another aspect, a vacuum assembly including a power head including a blower assembly, and a filter assembly, a collection container coupled to the power head, where together the collection container and the power head at least partially define a working volume therebetween, and where the filter assembly is in fluid communication with the working volume, and a cleaning assembly, where the cleaning assembly is configured to selectively engage the filter assembly to dislodge at least a portion of the dust and debris contained therein.

Alternatively or additionally, in any combination, where the cleaning assembly is at least partially positioned within the working volume.

Alternatively or additionally, in any combination, where the cleaning assembly also includes a housing, and wherein the housing at least partially defines the working volume.

Alternatively or additionally, in any combination, where the housing includes a first connection interface configured to be releasably coupled to the power head, and a second connection interface configured to be releasably coupled to the collection container.

Alternatively or additionally, in any combination, where the collection container is directly coupled to the power head.

Alternatively or additionally, in any combination, where the filter assembly defines a filter axis, and where the cleaning assembly includes a cage that rotates with respect to the filter assembly about the filter axis.

Alternatively or additionally, in any combination, where the cleaning assembly is configured to selectively engage the filter assembly to dislodge at least a portion of the dust and debris contained therein without having to open to working volume.

In another aspect, a vacuum assembly including an air inlet through which untreated air may be collected, a blower assembly having a blower inlet and a blower outlet, a first storage volume in fluid communication with the air inlet and the blower inlet, a second storage volume, and a valve extending between and in fluid communication with both the first storage volume and the second storage volume, where the valve is adjustable between a first condition, in which the first storage volume is in fluid communication with the second storage volume, and a second condition, in which the second storage volume is not in fluid communication with the second storage volume.

Alternatively or additionally, in any combination, where the vacuum is operable in a first operating condition, in which the blower assembly is activated and the valve is in the second condition, and the vacuum is operable in a second operating condition, in which the blower assembly is not activated and the valve is in the first condition.

Alternatively or additionally, in any combination, where the blower assembly is configured to generate a zone of low pressure within the first storage volume when it is activated.

Alternatively or additionally, in any combination, further including a first housing containing the blower assembly therein, a second housing removably coupled to the first housing, where the second housing at least partially defines the first storage volume, and a third housing removably coupled to the second housing, where the third housing at least partially defines the second storage volume.

Alternatively or additionally, in any combination, where the first housing at least partially defines the first storage volume.

Alternatively or additionally, in any combination, where the second housing at least partially defines the second storage volume.

Alternatively or additionally, in any combination, where the valve is biased toward the second condition.

Alternatively or additionally, in any combination, where the valve includes a valve seat and a valve actuator movable into and out of engagement with the valve seat, and where the presence of a low-pressure zone within the first storage volume biases the valve actuator into engagement with the valve seat.

### BRIEF DESCRIPTION OF THE DRAWINGS

FIG. 1 is a perspective view of a vacuum assembly with a pre-separator incorporated therein.

FIG. 2 is a schematic view of the vacuum assembly of FIG. 1 in a first operating configuration.

FIG. 3 illustrates the vacuum assembly of FIG. 2 with the power head detached from the container.

FIG. 4 is a schematic view of the vacuum assembly of FIG. 1.

FIG. 5 is a top perspective view of the pre-separator of the vacuum assembly of FIG. 1.

FIG. 6 is a bottom perspective view of the pre-separator of FIG. 5.

FIG. 7 is a side view of the pre-separator of FIG. 5.

FIG. 8 is a top view of the pre-separator of FIG. 5.

FIG. 9 is a bottom view of the pre-separator of FIG. 5.

FIG. 10 is a front view of the pre-separator of FIG. 5.

FIG. 11 is a section view taken along line 11-11 of FIG. 8.

FIG. 12 is a perspective view of FIG. 11.

FIG. 13 is a section view taken along line 13-13 of FIG. 8.

FIGS. 14-17 illustrate another embodiment of a pre-separator.

FIG. 18 is a perspective view of a vacuum with a filter cleaner installed thereon.

FIG. 19 is an exploded view of the vacuum of FIG. 18.

FIG. 20 is a bottom perspective view of the vacuum of FIG. 18 with the storage container removed.

FIG. 21 is a side schematic view of the vacuum of FIG. 18.

FIG. 22 is a side schematic view of another embodiment of a vacuum with a filter cleaner installed thereon.

FIG. 23 is a side schematic view of another embodiment of a vacuum with a filter cleaner installed thereon.

FIG. 24 is a perspective view of a container adapter for use with a vacuum.

FIG. 25 is a side schematic view of the container adapter of FIG. 24 installed on a container and attached to a head unit.

FIG. 26 is a side schematic view of another embodiment of a container adapter installed on a container and attached to a head unit.

FIG. 27 illustrates another embodiment of a container adapter.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include hydraulic or electrical connections or couplings, whether direct or indirect.

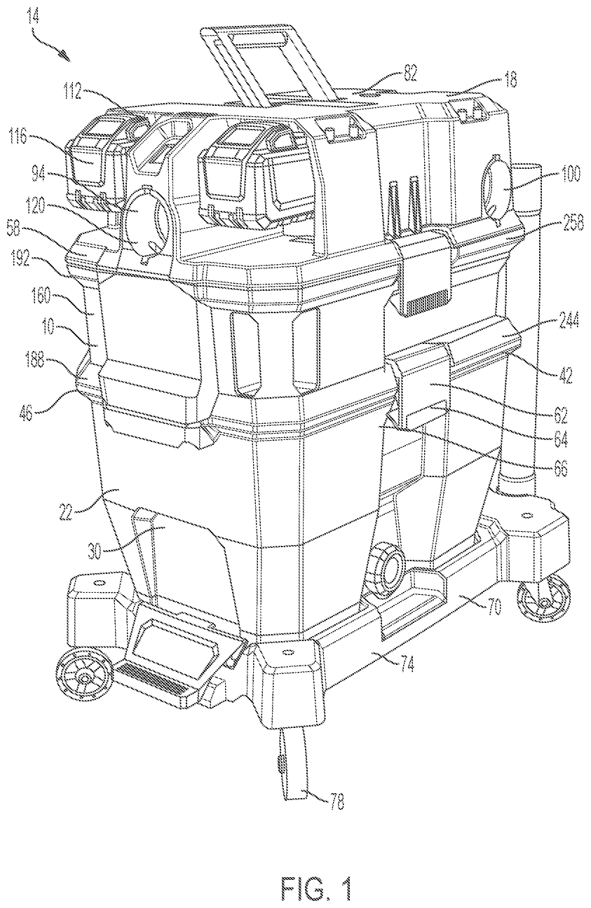

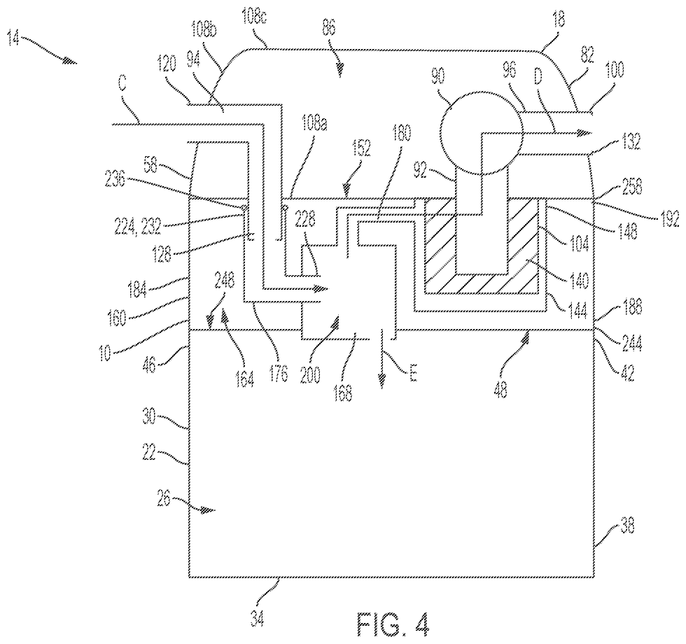

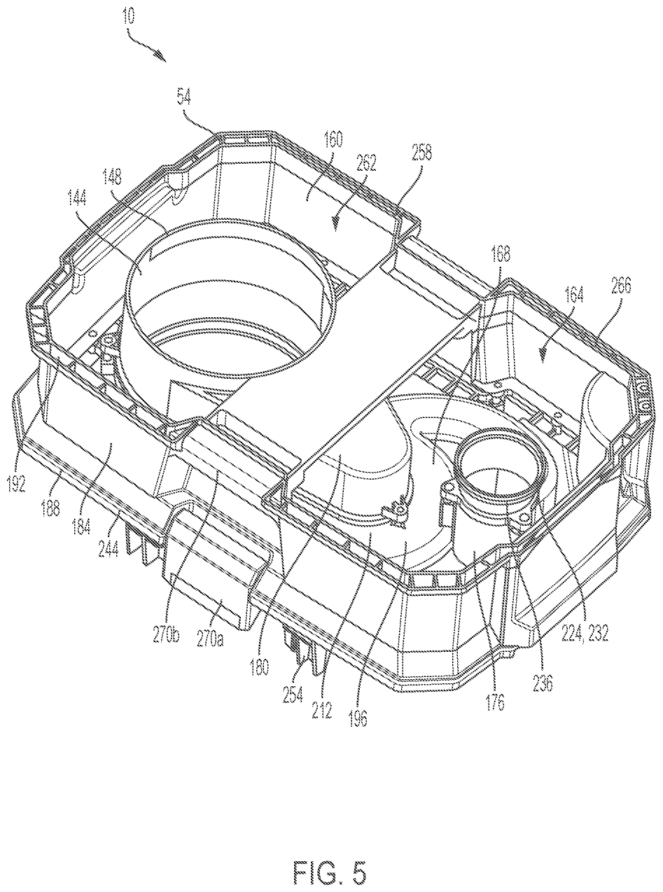

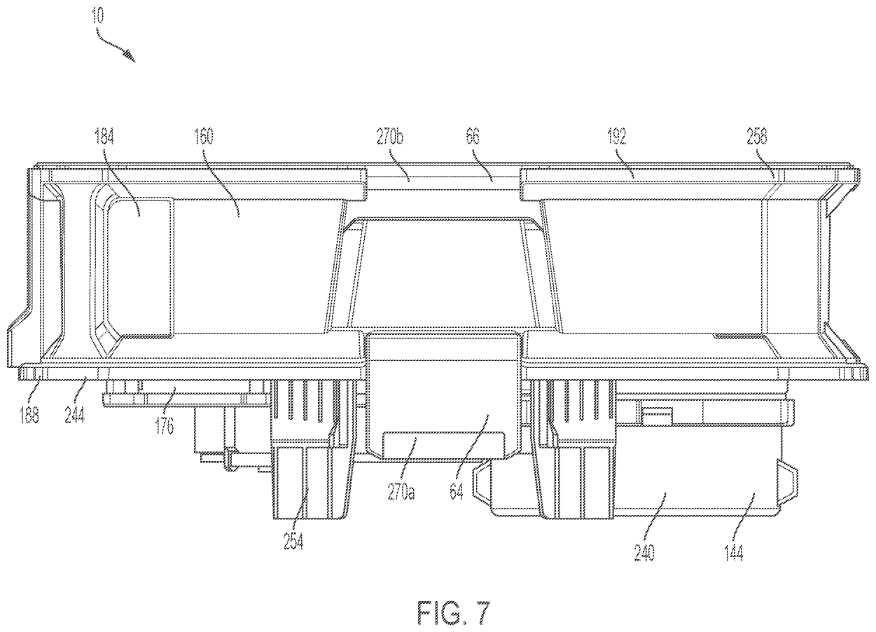

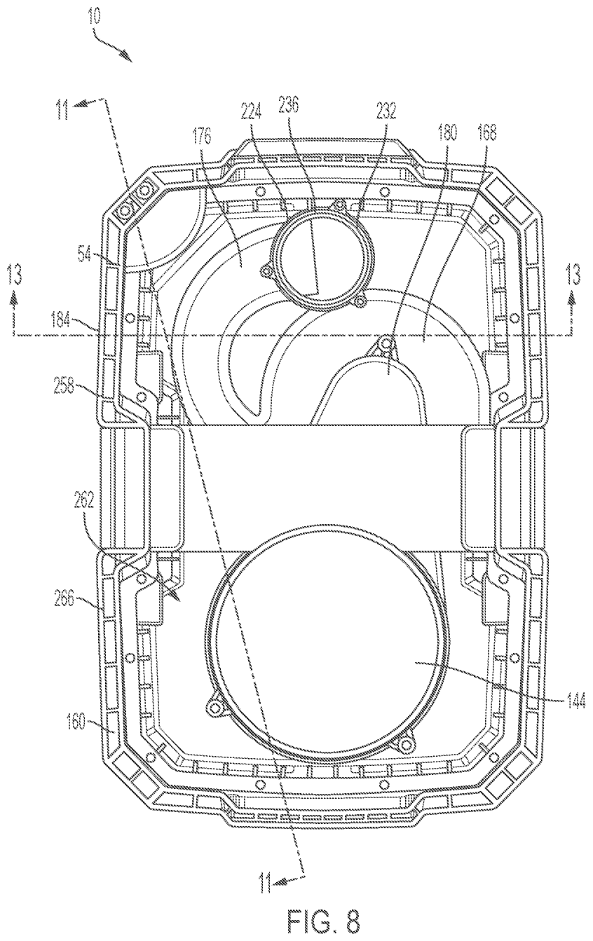

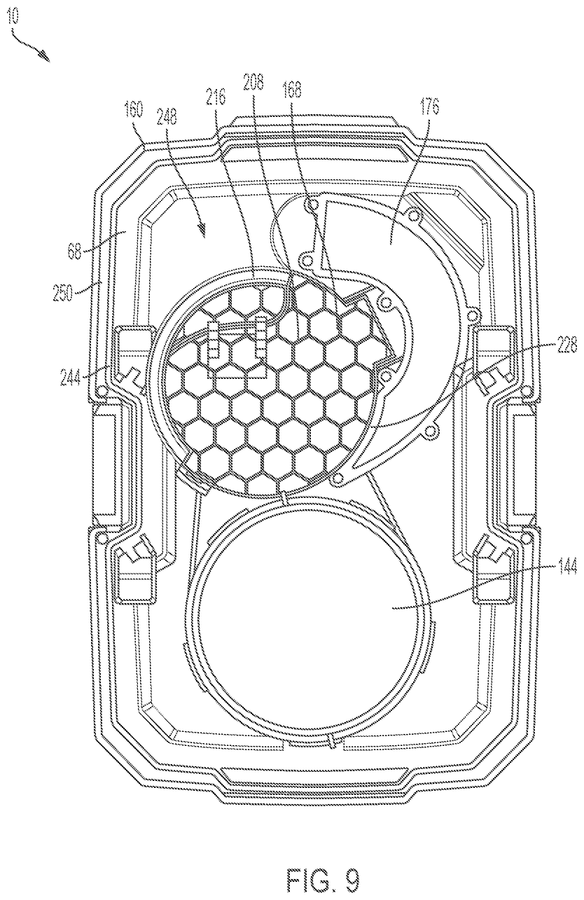

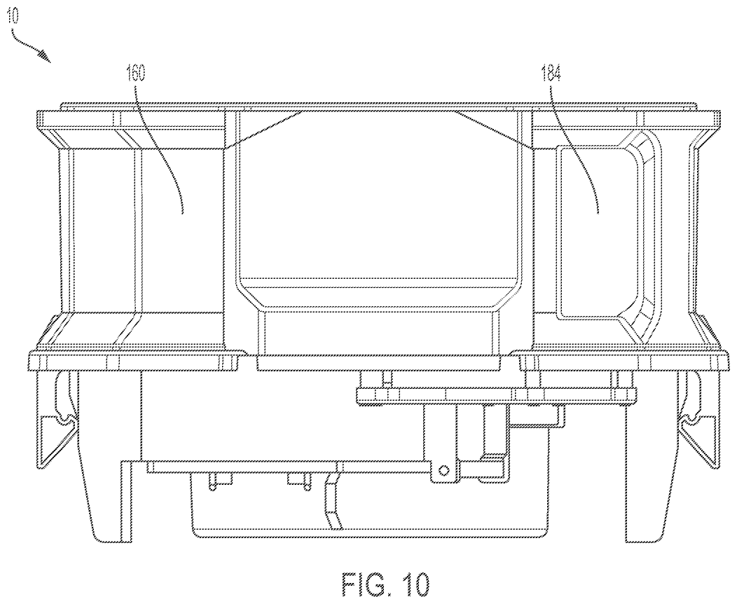

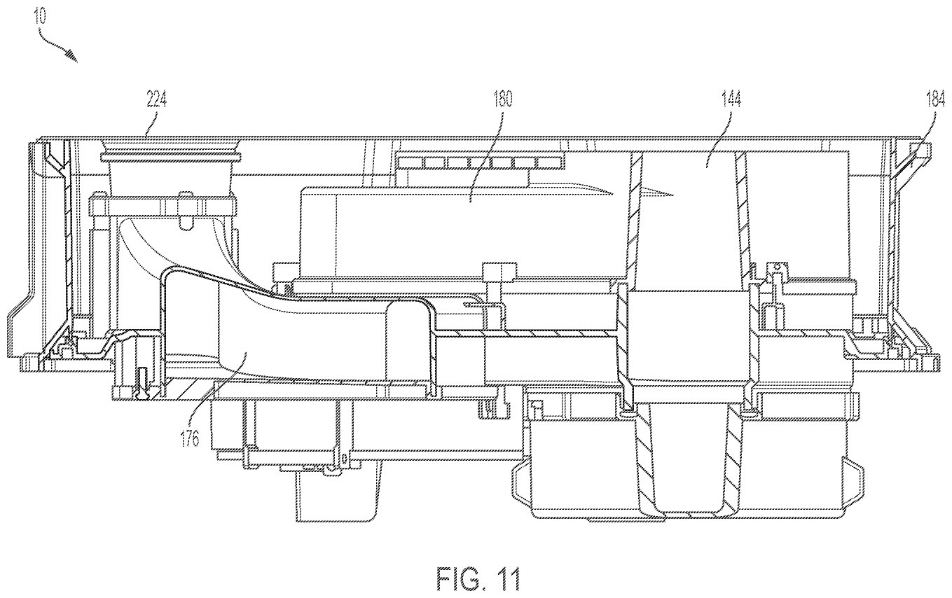

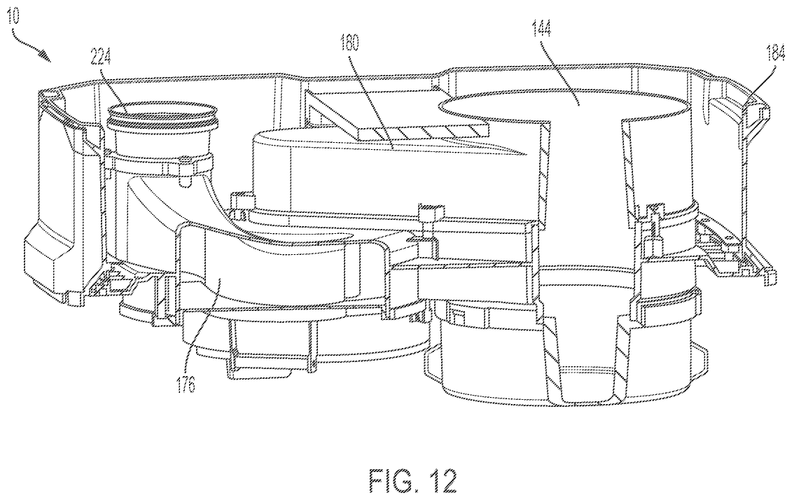

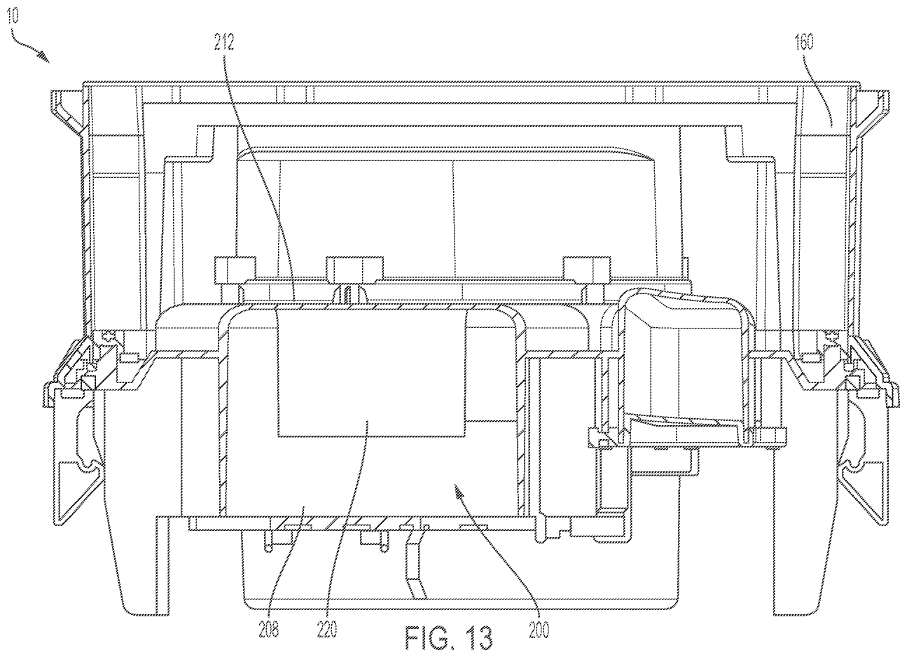

FIGS. 5-13 illustrate a pre-separator device 10 for use with a vacuum assembly 14 (e.g., a two-piece wet/dry vac). The pre-separator 10 is configured to be incorporated into the airflow path of the pre-existing vacuum assembly 14 without the need for any dedicated hoses or external connections (see FIGS. 1 and 4). More specifically, the pre-separator 10 may be installed (e.g., stacked) between the power head 18 and the collection container 22 of the vacuum assembly 14 such that the untreated air being drawn in by the power head 18 must first pass through and be processed by the pre-separator 10 before passing through the filter 140 of the power head 18 and being exhausted back out into the atmosphere.

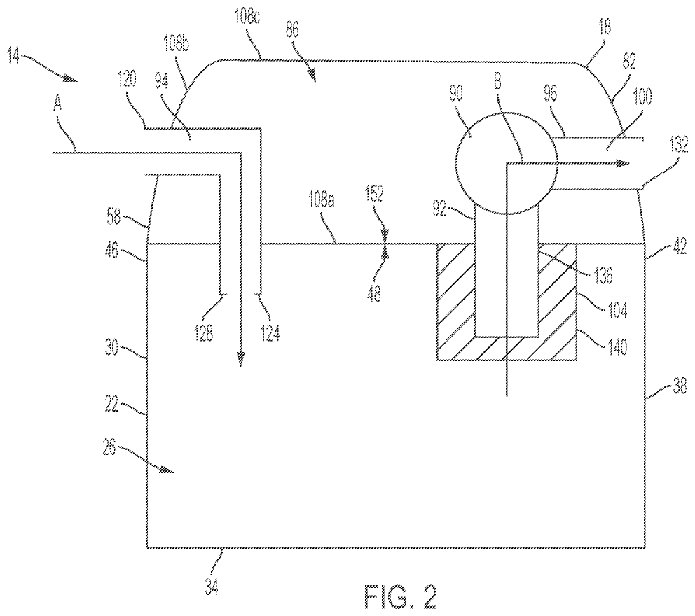

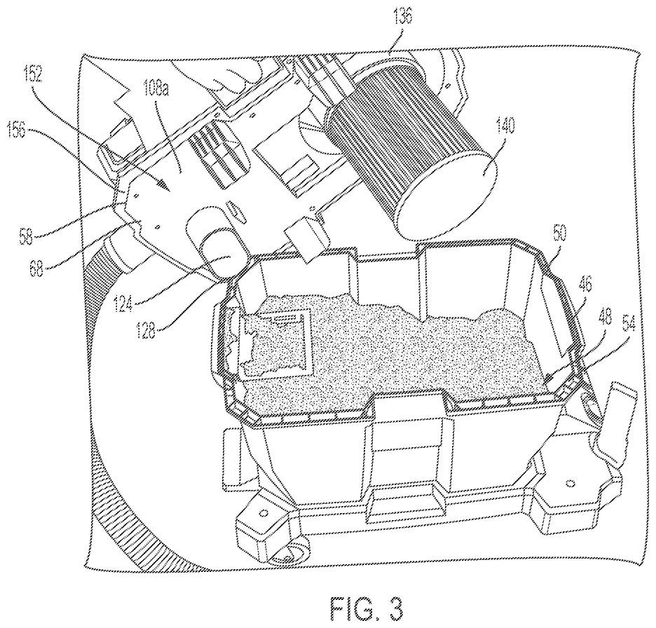

The vacuum assembly 14 of FIGS. 2 and 3 is a form of wet/dry vacuum assembly including a collection vessel or container 22 defining a collection volume 26 therein, and a power head 18 couplable to the collection container 22.

The container 22 of the vacuum assembly 14 includes a body 30 at least partially defining the collection volume 26 therein. More specifically, the body 30 includes a base wall 34, and a plurality of side walls 38 extending from the periphery of the base wall 34 to define an open end 42 opposite thereof. The resulting open end 42 provides access to the collection volume 26. In the illustrated embodiment, the base wall 34 is generally octagonal in shape having eight side walls 38 extending upwardly therefrom. However, in other embodiments, different shaped containers may be present.

As shown in FIG. 3, the open end 42 of the container 22 forms a first connection interface 46 to which other devices (e.g., the power head 18 or the pre-separator 10) may be releasably attached. During use, the first connection interface 46 serves to physically align the connected elements (e.g., vertically, horizontally, and rotationally) while also establishing an internal connection region 48. The internal connection region 48, in turn, serves as an area where various operable connections (e.g., airflow passage connections, electrical connections, debris passage connections, and the like) may be made and the transfer of material (e.g., air, dust, debris, and the like) may occur within the confines of the assembled vacuum's structure.

The first connection interface 46 includes a perimeter 50 extending along the perimeter of the open end 42 of the side walls 38 to define and enclose the first connection region 48. In the illustrated embodiment, the perimeter 50 also serves as a locating element and includes a ridge 54 extending along the entire perimeter of the open end 42 of the side walls 38 that is sized and shaped to be nested within a corresponding groove 68 formed in the corresponding connection interface (e.g., the second connection interface 58 of the power head 18; discussed below). During use, the open end 42 of the collection volume 26 is open to the first connection region 48 of the first connection interface 46 so that dirt and debris may pass into the collection volume 26 via the first connection region 48.

While the illustrated embodiment shows the first connection interface 46 having a ridge 54 or male alignment feature to be paired with a corresponding groove or female alignment feature, it is understood that in other embodiments the first connection interface 46 may include a groove or a combination of ridges and grooves. In still other embodiments, the perimeter 50 may include a series of pins, recesses, interlocking teeth, and the like positioned along the perimeter of the open end 42. In still other embodiments, one or more internal connection elements (e.g., pins, slots, apertures, teeth, and the like) may be present within the connection region 48 and separate from the perimeter 50. In still other embodiments, the perimeter 50 may include a seal incorporated therein to help fluidly isolate the first connection region 48 from the exterior surroundings.

As shown in FIG. 1, the container 22 also includes a coupling element 62 positioned proximate the first connection interface 46 and configured to form a releasable connection with a corresponding coupling element 62 of either the power head 18 or the pre-separator 10. More specifically, the container 22 includes a lip 66 formed into the body 30 thereof to which a latch 64 may releasably engage. While the illustrated coupling element 62 is a lip 66 to be used together with a corresponding latch 64, it is understood that in other embodiments the positions may be reversed. In still other embodiments, other forms of connection (e.g., latches, clamps, clips, and the like) may be used.

In the illustrated embodiment, the container 22 also includes a transport assembly 70 attached thereto to allow the container 22 to be rolled over a support surface (e.g., a floor and the like). More specifically, the transport assembly 70 includes a frame 74 sized to receive and support the container 22 thereon, and a plurality of caster wheels 78. While the illustrated transport assembly 70 is separate from the container body 30, it is understood that in other embodiments the transport assembly 70 may be formed integrally therewith.

As shown in FIGS. 1 and 2, the power head 18 of the vacuum assembly 14 includes a housing 82 at least partially defining a power head volume 86, a blower assembly 90 at least partially positioned within the power head volume 86, an inlet passage 94 open to the exterior of the housing 82, an outlet passage 100 open to the exterior of the housing 82, and a filter assembly 104.

The housing 82 of the power head 18 includes a series of walls positioned to at least partially enclose the power head volume 86 therein. More specifically, the housing 82 includes a bottom or base wall 108a, one or more side walls 108b extending from the base wall 108a, and a top wall 108c enclosing the side walls 108b opposite the base wall 108a. In the illustrated embodiment, the housing 82 also forms one or more battery ports 112 into which rechargeable batteries 116 may be inserted to power the blower assembly 90.

The inlet passage 94 of the power head 18 includes a fluid passage or channel configured to receive untreated air from a hose or other vacuum accessory and convey the untreated air to one of the container volume 26 and/or the pre-separator device 10. More specifically, the inlet passage 94 includes a first end 120 that is open to the exterior of the housing 82 to serve as a mounting point to which a hose or other vacuum accessory (not shown) may be releasably attached during use. The inlet passage 94 also includes second end 124 opposite the first end 120 that extends downwardly away from the base wall 108 to form a cylindrical projection having an open distal end 128 (see FIG. 3). In the illustrated embodiment, the distal end 128 of the second end 124 of the inlet passage 94 includes a rounded tip where only half of the exterior wall is removed. However, in other embodiments, different tip geometries may be present.

The outlet passage 100 of the power head 18 includes a fluid passageway configured to convey the exhausted air from the blower assembly 90 to the outside of the housing 82. More specifically, the outlet passage 100 includes a first end 132 open to the exterior of the housing 82 to serve as a mounting point for a hose or other vacuum accessory (e.g., for use when the vacuum is in a blower mode). While the illustrated outlet passage 100 is sized and shaped to connect with a hose or tube, it is understood that in other embodiments a filter or grate may be incorporated into the outlet passage 100 to minimize noise or external access to the passage 100.

The filter assembly 104 of the power head 18 includes a filter mounting point 136 formed into the base wall 108a to which a filter 140 may be releasably attached. When a filter 140 is attached to the mounting point 136, the filter 140 itself extends downwardly away from the base wall 108a of the housing 82. During use, the filter 140 is oriented and positioned such that it will extend into one of the container volume 26 (e.g., when the power head 18 is attached directly to the container 22; see FIG. 2) or the filter casing 144 (e.g., when the power head 18 is attached directly to the pre-separator 10; see FIG. 4).

The blower assembly 90 of the power head 18 includes a blower or fan configured to generate an airflow within the vacuum assembly 14. More specifically, the blower assembly 90 includes a blower inlet 92 that is in fluid communication with and draws air through the filter 140, and a blower outlet 96 that is open and exhausts air to the exterior of the housing 82 via the outlet passage 100. During operation, the blower assembly 90 is intended to draw power from a power source (e.g., rechargeable batteries 116 and/or an outlet source).

As shown in FIG. 3, the base wall 108a of the housing 82 of the power head 18 forms a second connection interface 58 to which other devices (e.g., the container 22 or the pre-separator 10) may be releasably attached. Similar to the first connection interface 46, the second connection interface 58 serves to physically align the connected elements while also establishing a second internal connection region 152. The second internal connection region 152, in turn, serves as an area within which various operable connections (e.g., airflow passage connections, electrical connections, debris passage connections, and the like) may be made within the confines of the combined vacuum structure.

The second connection interface 58 includes a perimeter 156 extending along the outer edge of the base wall 108a to define and enclose the second connection region 152. In the illustrated embodiment, the perimeter 156 also serves as a locating element and includes a groove 68 extending along the entire perimeter of the base wall 108a that is sized and shaped to receive the corresponding ridge 54 of the first connection interface 46 therein. The distal end 128 of the inlet passage 94 and the filter mounting point 136 (and attached filter 140) are both positioned within and open to the second connection region 152.

During use, the illustrated second connection interface 58 is configured to provide a pair of operable connections within the internal connection region 152. Specifically, when the power head 18 is attached directly to the pre-separator 10, the pair of operable connections are formed between the inlet passageway 94 and the feed passageway 176; and between the filter casing 144 and the filter assembly 104. When the power head 18 is attached directly to the container 22, the pair of operable connections are formed between the inlet passageway 94 and the collection volume 26, and the filter assembly 104 and the collection volume 26.

While the illustrated embodiment shows the second connection interface 58 having a groove 68 or female alignment feature to be paired with a corresponding ridge 54 or male alignment feature, it is understood that in other embodiments the perimeter 156 of the second connection interface 58 may include a ridge or a combination of ridges and grooves. In still other embodiments, the perimeter 156 may include a series of pins, recesses, interlocking teeth, and the like positioned along the perimeter of the base wall 108a. In still other embodiments, one or more internal connection elements (e.g., pins, slots, apertures, teeth, and the like) may be present within the connection region 152 and separate from the perimeter 156. In still other embodiments, the perimeter 156 may include a seal incorporated therein to help fluidly isolate the first connection region 48 from the exterior surroundings.

As shown in FIG. 1, the power head 18 also includes a coupling element 62 positioned proximate the base wall 108a and configured to form a releasable connection with a corresponding coupling element 62 of either the container 22 or the pre-separator 10. More specifically, the power head 18 includes a latch 64 pivotably coupled to the housing 82 that is sized and shaped to releasably engage a corresponding lip 66 to secure the two elements together. While the illustrated coupling element 62 is a latch 64 to be used together with a corresponding lip 66, it is understood that in other embodiments the positions may be reversed. In still other embodiments, other forms of connection (e.g., latches, clamps, clips, and the like) may be used.

As shown in FIGS. 5-13, the pre-separator 10 is configured to serve as an accessory for use with a pre-existing vacuum assembly 14 providing improved dirt and debris separating capabilities and extended intake filter 140 life. More specifically, the pre-separator 10 is intended to provide supplemental dust and debris separation capabilities using cyclonic action before the air reaches the filter 140 of the power head 18. By doing so, the load placed on the filter 140 is greatly reduced as the amount of dust and debris that actually reaches the filter 140 is reduced significantly. The pre-separator 10 is also configured so that it can be incorporated into an existing vacuum assembly 14 without the need of any dedicated hoses or external connections. More specifically, the pre-separator 10 may be placed within the airflow path of the existing vacuum assembly 14 using only internal connections (e.g., connections within the interior of the combined structure of the assembled vacuum).

The illustrated pre-separator 10 includes a housing 160 defining a pre-separator volume 164, a cyclonic separator 168 at least partially positioned within the pre-separator volume 164, a filter casing 144 at least partially positioned within the pre-separator volume 164, a feed passageway 176 to convey air into the cyclonic separator 168, and an intermediate passageway 180 to convey air from the cyclonic separator 168 to the filter casing 144.

The separator housing 160 includes a perimeter wall 184 extending around the perimeter of the pre-separator 10 to produce a first or container end 188, and a second or power head end 192 opposite the first end 188. The perimeter wall 184 also encloses and defines the pre-separator volume 164. As shown in FIG. 1, the first end 188 of the perimeter wall 184 has a cross-sectional shape that generally corresponds to the cross-sectional shape of the open end 42 of the container 22 while the second end 192 of the perimeter wall 184 has a cross-sectional shape that generally corresponds to the shape of the base wall 108a of the power head 18. In the illustrated embodiment, both the first end 188 and the second end 192 have a generally octagonal shapes similar to the octagonal cross-sectional shapes of the container 22 and power head unit 18, respectively.

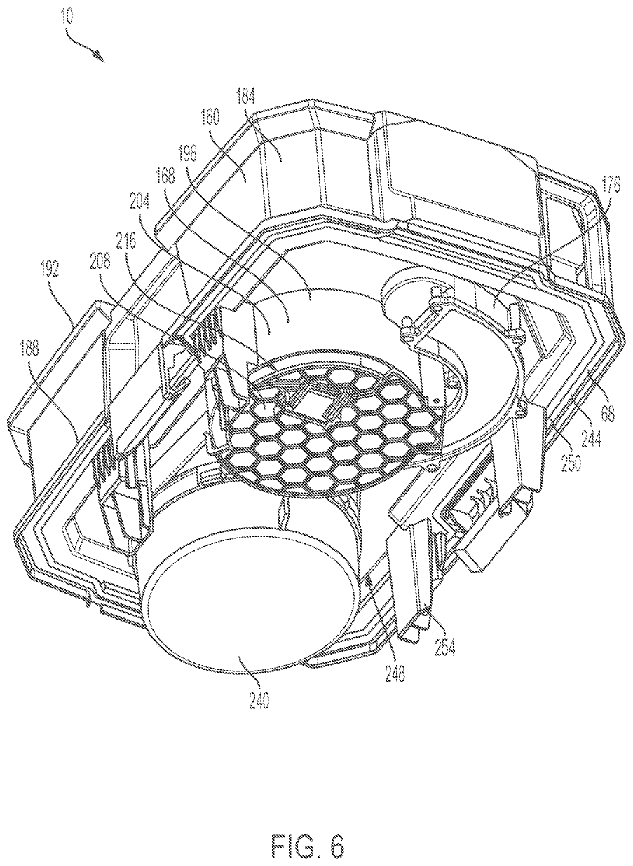

As shown in FIGS. 4 and 6, the pre-separator 10 includes a cyclonic separator 168 configured to remove dust and debris from the air flowing therethrough and subsequently discharge the separated dust and debris into the collection volume 26 of the container 22. More specifically, the cyclonic separator 168 receives a flow of untreated air via the feed passage 176 and directs the untreated airflow into a cyclonic or circular flow path. The centrifugal forces generated from the circular flow path then forces the relatively more dense dust and debris particles to separate from the airflow and collect in the bottom of the cyclonic separator 168. The treated air can then exit the separator 168 via the intermediate passage 180 while all separated dust and debris particles are directed into the container 22 for subsequent disposal. In the illustrated embodiment, the cyclonic separator 168 includes a substantially cylindrical body 196 defining a cyclonic volume 200 therein. The body 196, in turn, includes an annular wall 204, a bottom wall 208 enclosing the bottom of the annular wall 204, and a top wall 212 opposite the bottom wall 208 that encloses the top of the annular wall 204.

As shown in FIGS. 4 and 6, the bottom wall 208 of the cyclonic separator 168 defines a discharge port 216 through which dirt and debris separated from the airflow may be deposited into the collection volume 26 of the container 22. In the illustrated embodiment, the bottom wall 208 is formed separately from the remainder of the body 196 (e.g., the annular wall 204) and is pivotably attached thereto so that the user may manually open the bottom wall 208 to gain access to the cyclonic volume 200 for cleaning and the like.

The top wall 212 of the cyclonic separator 168 defines an exit aperture 220 through which the treated airflow may exit the cyclonic volume 200 and enter the intermediate passageway 180. In the illustrated embodiment, the exit aperture 220 is located at the radial center of the cylindrical body 196 so that only treated air exits therefrom. However, in other embodiments, different forms of exit aperture 220 may be present.

The feed passage 176 of the pre-separator 10 includes an elongated channel configured to receive an untreated airflow from the inlet passage 94 of the power head 18 and direct the untreated airflow into the cyclonic volume 200 of the cyclonic separator 168. More specifically, the feed passage 176 includes a first or connector end 224 configured to sealably couple with the distal end 128 of the inlet passage 94, and a second end 228 configured to direct the airflow into the cyclonic volume 200.

As shown in FIG. 5, the first end 224 of the feed passageway 176 forms a connector interface 232 configured to selectively form an air-tight seal with the distal end 128 of the inlet passageway 94. More specifically, the connector interface 232 includes an annular gasket 236 sized and shaped so that when the distal end 128 of the inlet passageway 94 is axially inserted into the first end 224 of the feed passageway 176 the gasket 236 forms an air-tight seal with the outer surface thereof. One advantage of the illustrated gasket 236 is that the distance the distal end 128 is inserted into the first end 224 of the feed passageway 176 is not critical, allowing for more flexibility in the overall design. Furthermore, the rounded tip of the distal end 128 of the inlet passageway 94 provides a level of flexibility in radial alignment. While the annular rubber gasket 236 is shown in the illustrated embodiment, it is understood that in other embodiments different forms of selective air-tight connections may be used between the inlet passageway 94 and the feed passageway 176.

The second end 228 of the feed passageway 176 is open to and passes through the annular wall 204 of the cyclonic separator 168. More specifically, the second end 228 of the feed passageway 176 is sized, shaped, and contoured such that the airflow being discharged into the cyclonic volume 200 will take on annular or cyclonic flow characteristics.

The filter casing 144 of the pre-separator 10 is at least partially positioned within the pre-separator volume 164 and is sized and shaped to receive at least a portion of the filter 140 therein. More specifically, the filter casing 144 includes an open end 148 into which the filter 140 can be axially inserted and is sized such that the walls of the filter casing 144 are spaced a distance from the exterior of the filter 140 to allow for the free flow of air to the entire exterior surface thereof.

In the illustrated embodiment, the enclosed underside of the filter casing 144 is formed by a removable cap 240. As such, the user may remove the cap 240 (e.g., via the first end 120) to gain access to the interior of the filter casing 144 while the pre-separator 10 is still attached to the power head 18. The cap 240 also allows the user to remove and replace the filter 140 with the pre-separator 10 attached to the power head 18.

The intermediate passageway 180 of the pre-separator 10 includes an elongated passageway extending between the exit aperture 220 of the cyclonic separator 168 and the interior of the filter casing 144. During use, a treated airflow exits the cyclonic separator 168 via the exit aperture 220 whereby the intermediate passageway 180 conveys the treated airflow to the filter casing 144.

As shown in FIG. 6, the first end 188 of the perimeter wall 184 of the housing 160 forms a third connection interface 244 to which other devices (e.g., the container 22) may be releasably attached. During use, the third connection interface 244 serves to physically align the pre-separator 10 with the container 22 while also at least partially establishing a third internal connection region 248. The third internal connection region 248, in turn, generally corresponds and aligns with the first internal connection region 48 allowing the internal passage of dust and debris therebetween. The discharge port 216 of the cyclonic separator 168 is positioned within the third internal connection region 248 and open to the third connection interface 244.

During use, dust and debris particles discharged via the discharge port 216 are able to pass into and be collected within the collection volume 26 via the first and second internal connection regions 48, 248.

The third connection interface 244 includes a perimeter 250 extending along the first end 188 of the perimeter wall 184 to enclose the third connection region 248. In the illustrated embodiment, the perimeter 250 also serves as a locating device and includes a groove 68 extending along the entire perimeter thereof that is sized and shaped to at least partially receive the corresponding ridge 54 of the first connection interface 46 therein. The interaction between the groove 68 and ridge 54 are configured to restrict relative lateral movement between the pre-separator 10 and the container 22.

While the illustrated embodiment shows the third connection interface 244 as having a groove 68 or female alignment feature to be paired with a corresponding ridge 54 or male alignment feature, it is understood that in other embodiments the third connection interface 244 may be a ridge or a combination of grooves and ridges. In still other embodiments, the perimeter 250 may include a series of pins, recesses, interlocking teeth, and the like positioned along the perimeter of the first end 188. In still other embodiments, one or more internal connection elements (e.g., pins, slots, apertures, teeth, and the like) may be present within the connection region 248 and separate from the perimeter 250. In still other embodiments, the perimeter 250 may include a seal incorporated therein to help fluidly isolate the third connection region 248 from the exterior surroundings.

The third connection interface 244 also includes a set of alignment shafts 254 extending outwardly beyond the first end 188. When assembled, the alignment shafts 254 are intended to be inserted into the collection volume 26 and contact the interior surface of the body thereof such that the shafts 254 help to relatively align the pre-separator 10 with the container 22 as they are being coupled together.

As shown in FIG. 5, the second end 192 of the perimeter wall 184 of the housing 160 forms a fourth connection interface 258 to which other devices (e.g., the power head 18) may be releasably attached. During use, the fourth connection interface 258 serves to physically align the pre-separator 10 with the power head 18 while also at least partially establishing a fourth internal connection region 262. The fourth internal connection region 262, in turn, serves as an area within which various operable connections (e.g., airflow passage connections, electrical connections, debris passage connections, and the like) may be made within the confines of the combined vacuum structure.

The fourth connection interface 258 includes a perimeter 266 extending along the second end 192 of the perimeter wall 184 to enclose the fourth connection region 262. In the illustrated embodiment, the perimeter 250 also serves as a locating device and includes a ridge 54 extending along the entire perimeter thereof that is sized and shaped to at least partially receive the corresponding groove 68 of the second connection interface 58. The interaction between the groove 68 and ridge 54 are configured to restrict relative lateral movement between the pre-separator 10 and the power head 18. The first end 224 of the feed passage 176 and the open end 148 of the filter casing 144 are positioned within the fourth connection region 262 and open to the fourth connection interface 258.

During use a pair of operable connections (e.g., between the inlet passageway 94 and the feed passageway 176; and between the filter casing 144 and the filter assembly 104) are formed within the fourth internal connection region 262.

While the illustrated embodiment shows the fourth connection interface 258 as having a ridge 54 or male alignment feature to be paired with a corresponding groove 68 or male alignment feature, it is understood that in other embodiments the fourth connection interface 258 may be a groove or a combination of grooves and ridges. In still other embodiments, the perimeter 266 may include a series of pins, recesses, interlocking teeth, and the like positioned along the perimeter of the second end 192. In still other embodiments, one or more internal connection elements (e.g., pins, slots, apertures, teeth, and the like) may be present within the connection region 262 and separate from the perimeter 266. In still other embodiments, the perimeter 266 may include a seal incorporated therein to help fluidly isolate the fourth connection region 262 from the exterior surroundings.

As shown in FIG. 1, the pre-separator 10 also includes two pairs of coupling elements 270a, 270b. The coupling elements 270a, 270b are positioned proximate the first end 188 and the second end 192 and are configured to form a releasable connection with the container 22, and the power head 18, respectively. The first coupling element 270a includes a latch 64 pivotably coupled to the pre-separator 10 while the second coupling element 270b includes a lip 66 integrally formed into the exterior wall. It is understood that in other embodiments the positions may be reversed. In still other embodiments, other forms of connection (e.g., latches, clamps, clips, and the like) may be used.

During use, the vacuum assembly 14 is operable in a first configuration, in which the power head 18 is attached directly to the container 22, and a second configuration, in which the pre-separator 10 is positioned between and attached to both the power head 18 and the container 22. When assembled in either the first configuration or the second configuration, the user may then utilize the vacuum assembly 14 in a vacuum mode (e.g., by inserting a hose or other vacuum accessory into the first end 120 of the inlet passageway 94), or in a blower mode (e.g., by inserting a hose or other vacuum accessory into the first end 132 of the outlet passage 100).

To operate the vacuum assembly 14 in the first configuration in a vacuum mode, the user may first assemble the vacuum 14 by coupling the power head 18 to the container 22. To do so, the user introduces the power head 18 downwardly onto the top of the container 22 until the first connection interface 46 comes into contact with and engages the second connection interface 58 (e.g., the ridge 54 of the first connection interface 46 is at least partially received within the groove 68 of the second connection interface 58). By doing so, the distal end 128 of the inlet passage 94 and filter 140 of the filter assembly 104 are positioned at least partially within and in fluid communication with the collection volume 26. Once in place, the user may then secure the power head 18 to the container 22 using the coupling elements 62. The resulting vacuum assembly 14 provides one stage of air treatment (e.g., the filter 140).

With the vacuum 14 assembled, the user may then install a hose, tube, or other vacuum assembly to the first end 120 of the inlet passage 94. The user may then activate the power head 18 such that electrical power is provided to the blower assembly 90. The blower assembly 90, in turn, begins circulating air through the assembly 14 such that untreated air (A) collected by the user (e.g., via the hose) enters the power head 18 through the first end 120 of the inlet passage 94 and is directed into the collection volume 26. Upon exiting the inlet passage 94, larger debris particles and coarse dust will separate from the airflow and be collected in the collection volume 26. The untreated airflow (A) is then drawn toward and through the filter 140 where the sole stage of treatment will occur by the filter 140 to remove any remaining dust and debris particles. The final treated airflow (B) is then exhausted to the atmosphere via the outlet passage 100.

To operate the vacuum assembly 14 in the second configuration in the vacuum mode, the user may attach the power head 18 to the pre-separator 10. To do so, the user introduces the power head 18 downwardly onto the top of the pre-separator 10 until the second connection interface 58 of the power head 18 comes into contact with and engages the fourth connection interface 258 of the pre-separator 10 (e.g., the ridge 54 of the fourth connection interface 258 is at least partially received within the groove 68 of the second connection interface 58). When doing so, two connections are simultaneously made. First, the distal end 128 of the inlet passage 94 is received within and forms a fluid tight connection with the first end 224 of the feed passage 176, and second, the filter 140 is axially inserted into and positioned within the filter casing 144. Both connections are located within their respective internal connection regions 152, 262.

Once in place, the power head 18 and the pre-separator 10 can be secured together by engaging the latches 64 of the second coupling elements 270b of the pre-separator 10 with the lips 66 of the coupling elements 62 of the power head 18. The resulting combined structure provides two successive stages of air treatment for any air drawn in via the inlet passage 94, the first stage being the cyclonic action of the cyclonic separator 168 and the second stage being the filter 140. The resulting flow path (e.g., through the cyclonic separator 168 and filter 140) is produced with all internal fluid connections between the pre-separator 10 and the power head 18. Stated differently, all airflow connections between the pre-separator 10 and power head 18 are contained inside the resulting combined structure comprising the housing 82 of the power head 18 and the housing 160 of the pre-separator. No external connections (e.g., hoses, tube, pipes, and the like) are required.

For example, a first flow path extending from the first end 120 of the inlet passage 94 to the second end 228 of the feed passage 176 passes through both the second internal connection region 152 and the fourth internal connection region 262. Similarly, a second flow path extending from the exit aperture 220 to first end 132 of the outlet passage 100 also passes through both the second internal connection region 152 and the fourth internal connection region 262.

With the power head 18 secured to the pre-separator 10, the resulting assembly may then be attached to the container 22. To do so, the user introduces the power head 18/pre-separator 10 assembly downwardly onto the top of the container 22 until the third connection interface 244 of the pre-separator 10 comes into contact with and engages the first connection interface 46 of the container 22 (e.g., the ridge 54 of the first connection interface 46 is at least partially received within the groove 68 of the third connection interface 244). By doing so, the discharge port 216 is placed in fluid communication with the collection volume 26.

With the vacuum 14 assembled, the user may then activate the power head 18 such that electrical power is provided to the blower assembly 90. The blower assembly 90, in turn, then begins circulating air through the assembly 14 such that untreated air (C) collected by the user (e.g., via the hose) enters the power head 18 via the first end 120 of the inlet passage 94 where it is conveyed via the feed passage 176 to the cyclonic volume 200 to undergo a first phase of treatment. Specifically, the cyclonic separator 168 directs the airflow into a cyclonic or circular path whereby the resulting centrifugal force separatees dirt and debris therefrom. The separated dirt and debris ar then collected within the volume 200 where it is eventually discharged into the collection volume 26 via the discharge port 216 (see Flow E).

Meanwhile, the treated air (D) exits the cyclonic volume 200 via the exit aperture 220 where it is directed into the filter casing 144 via the intermediate passageway 180. Once in the filter casing 144 the airflow undergoes a second stage of treatment as is passes through the filter 140, removing any remaining dust and debris therefrom. The twice treated air is then exhausted to the surrounding atmosphere via the outlet passage 100.

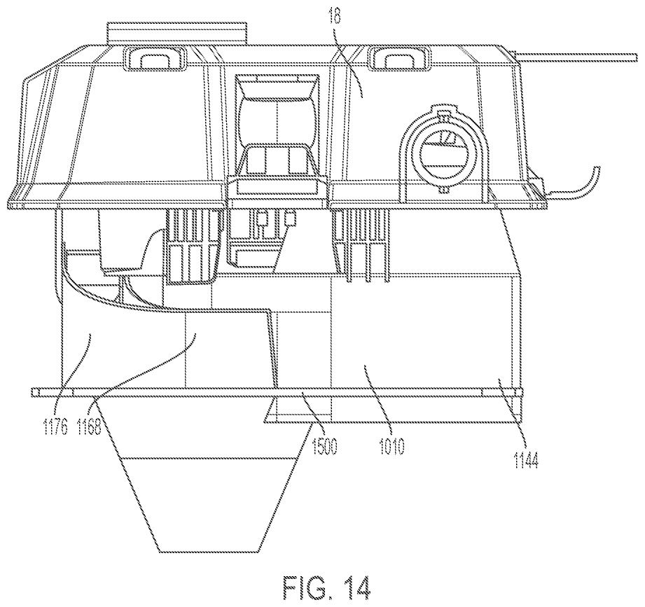

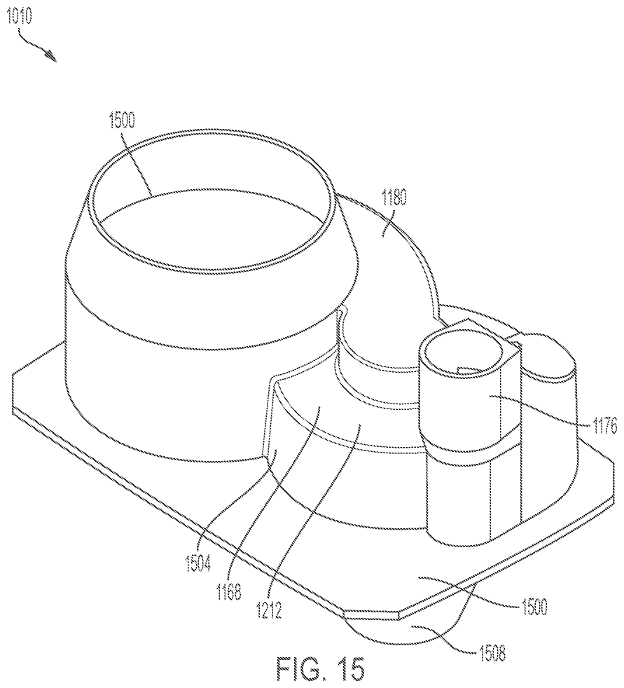

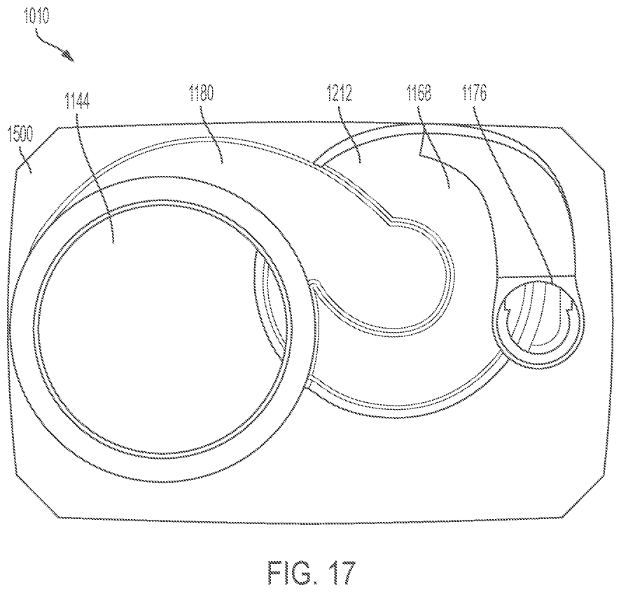

FIGS. 14-17 illustrate another embodiment of a pre-separator 1010. The pre-separator 1010 is substantially similar to the pre-separator 10 described above. As such, only the differences will be described in detail herein. The pre-separator 1010 includes a baseplate 1500 oriented generally perpendicular to the perimeter wall (not shown). The baseplate 1500, in turn, is configured to serve as a central frame or support for the pre-separator 1010 such that the cyclonic separator 1168, the filter casing 1144, the feed passageway 1176, and the intermediate passageway 1180 are all formed integrally therewith. In the illustrated embodiment, the baseplate 1500, at least a portion of the cyclonic separator 1168, at least a portion of the filter casing 1144, at least a portion of the feed passageway 1176, and at least a portion of the intermediate passageway 1180 are formed as a single piece of monolithic material. In some embodiments, the baseplate 1500, at least a portion of the cyclonic separator 1168, at least a portion of the filter casing 1144, at least a portion of the feed passageway 1176, and at least a portion of the intermediate passageway 1180 are molded as a single part.

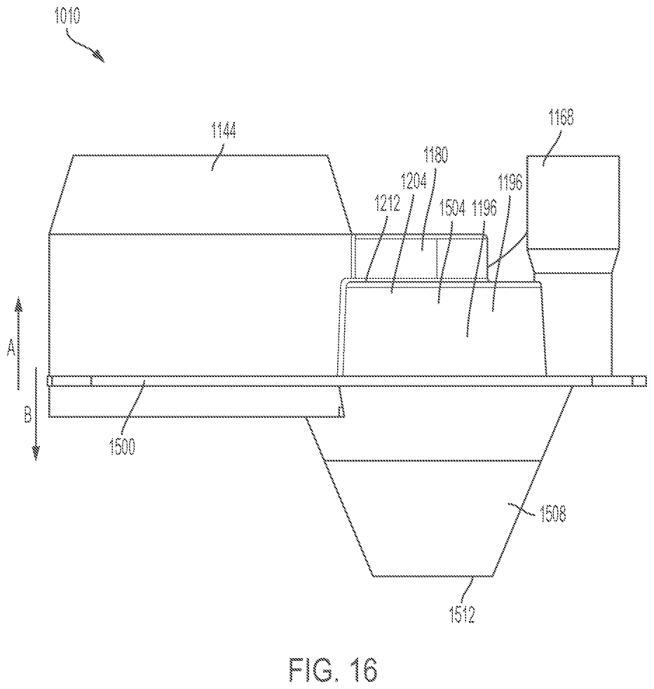

As shown in FIG. 16, the cyclonic separator 1168 of the pre-separator 1010 includes a first portion 1504, and a second portion 1508 extending axially from the first portion 1504. More specifically, the first portion 1504 includes a substantially cylindrical body 1196 extending in a first direction A from the baseplate 1500 and defining a cyclonic volume therein. The body 1196, in turn, includes an annular wall 1204, and a top wall 1212 opposite the baseplate 1500.

The second portion 1508 of the cyclonic separator 1168 is substantially frustoconical in shape extending in a second direction B from the baseplate 1500 opposite the first portion 1504 to define an outlet 1512. More specifically, the second portion 1508 shrinks in cross-sectional shape as it extends away from the baseplate 1500 to define the outlet 1512. In the illustrated embodiment, the interior volumes of the first portion 1504 and the second portion 1508 are continuous to form a single open space. However, in other embodiments, baffles, walls, vanes, and the like may be included within the cyclonic separator 1168 to aid the airflow therein.

During use, untreated air enters the pre-separator 1010 via the feed passage 1176 located in the annular wall 1204 of the first portion 1504. The untreated air is then directed into a cyclonic or circular flow path where the centrifugal forces generated causes the relatively more dense dust and debris particles to separate from the airflow. As the dust and debris travels along the second portion 1508 of the separator 1168, the narrowing volume causes the centrifugal forces to increase and finer dust particles to be separated out. Finally, the treated air exits the cyclonic separator 1168 via the intermediate passage 180 formed in the top wall 1212 while the separated debris is disposed into the collection volume 26 of the attached container 22 via the outlet 1512.

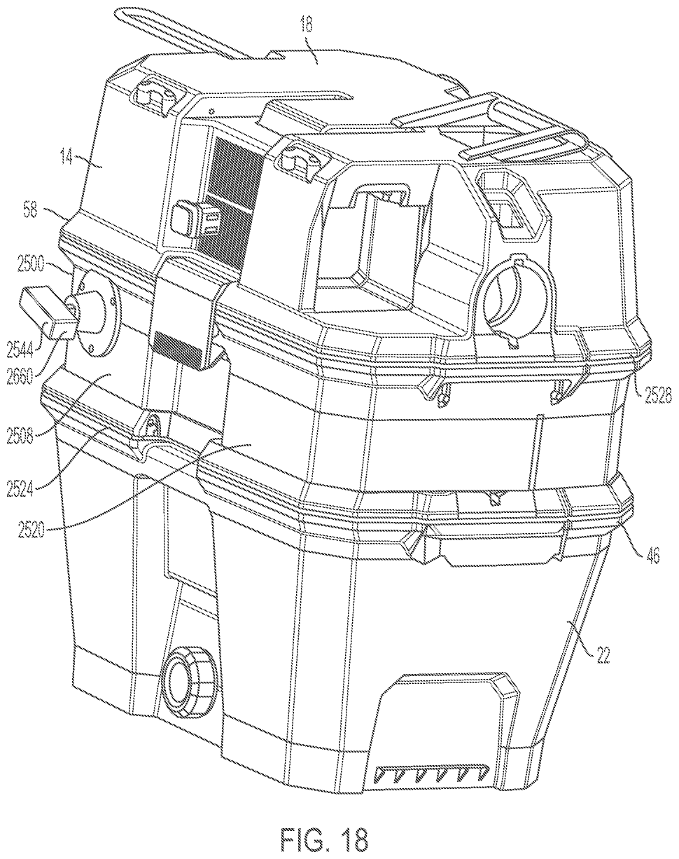

FIGS. 18-21 illustrate a filter cleaner 2500 for use with a pre-existing vacuum assembly 14 and configured to dislodge dust and debris from the filter 140 while maintaining the volumetric integrity of the 2532. More specifically, the filter cleaner 2500 includes a series of brushes or cleaning elements 2504 that selectively engage and dislodge dust and debris from the filter 140 without having to remove the filter 140 from the working volume 2532 and the working volume 2532 remains closed (e.g., without having to gain access to or otherwise open the working volume 2532). The filter cleaner 2500 is also configured so that it can be incorporated into an existing vacuum assembly 14 without the need of any dedicated hoses or external connections.

The illustrated filter cleaner 2500 includes a housing 2508, an internal frame 2512 supported within the housing 2508, and a cleaning assembly 2516 operably mounted to one of the housing 2508 and the internal frame 2512 and configured to selectively engage the filter 140 of an associated power head 18.

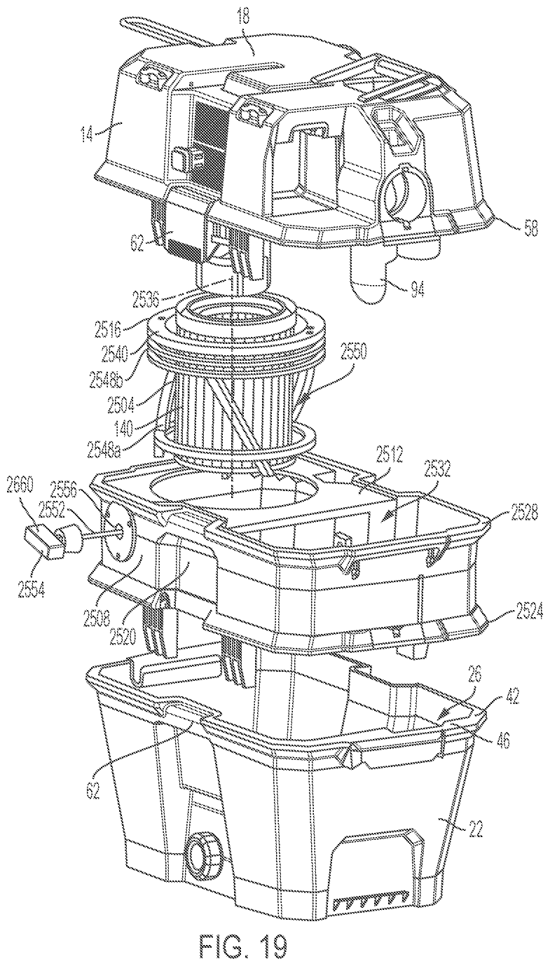

The housing 2508 of the filter cleaner 2500 includes a perimeter wall 2520 extending around the perimeter of the cleaner 2500 to produce a first or container end 2524, and a second or power head end 2528 opposite the first end 2524. As shown in FIGS. 18-19, the first end 2524 of the perimeter wall 2520 has a cross-sectional shape that generally corresponds to the cross-sectional shape of the open end 42 of the container 22 while the second end 2528 of the perimeter wall 2520 has a cross-sectional shape that generally corresponds to the shape of the base wall 108a of the power head 18. In the illustrated embodiment, both the first end 2524 and the second end 2528 have generally octagonal shapes similar to the octagonal cross-sectional shape of the container 22 and the power head unit 18, respectively.

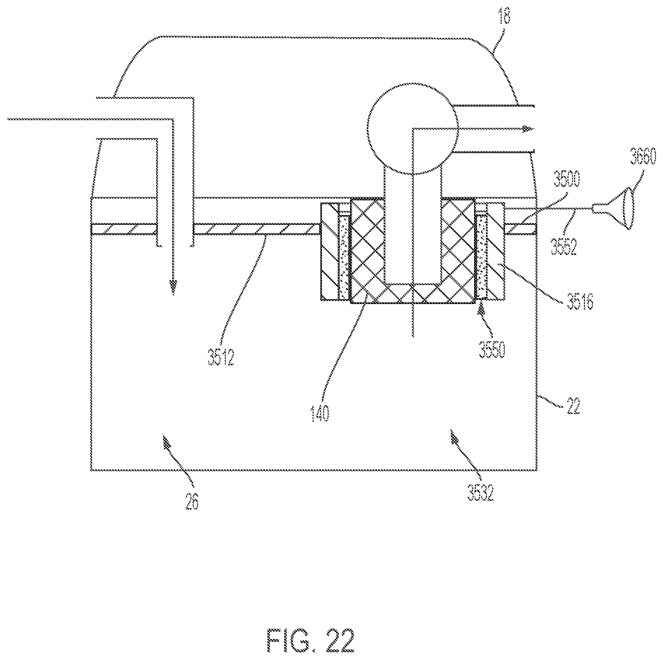

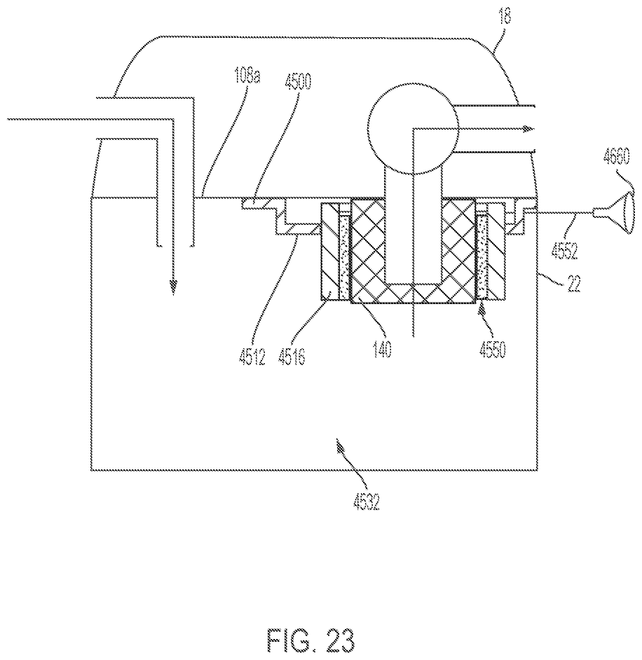

When the filter cleaner 2500 is installed between the container 22 and the power head 18, the three elements 18, 22, 2500 at least partially define a working volume 2532 therein. The working volume 2532, in turn, is in fluid communication with the collection volume 26 of the container 22, the inlet passage 94 of the power head 18, and the filter 140 of the power head 18. In the illustrated embodiment, working volume 2532 may be at least partially defined by portions of the perimeter wall 2520, the power head 18, and the container 22. However, in other embodiments, only the head unit 18 and the container 22 may define the working volume 2532 (see FIGS. 22 and 23). Furthermore, the working volume 2532 may be configured so that when the filter cleaner 2500 is coupled to both the power head 18 and the container 22, that the working volume 2532 may be closed-off or sealed from the surrounding environment.

The internal frame 2512 of the filter cleaner 2500 is at least partially supported within the working volume 2532 via the perimeter wall 2520 of the housing 2508. During use, the internal frame 2512 is configured to provide rigidity to the overall housing structure and support and position the cleaning assembly 2516 relative to the filter 140. More specifically, the internal frame 2512 is configured to rotatably support the cleaning assembly 2516 so it can rotate co-axially relative to the axis 2536 of the filter 140. The frame 2512 is also shaped to allow the filter 140 fluid access through to the collection volume 26 of the container, and to allow the inlet passage 94 fluid access through to the collection volume 26.

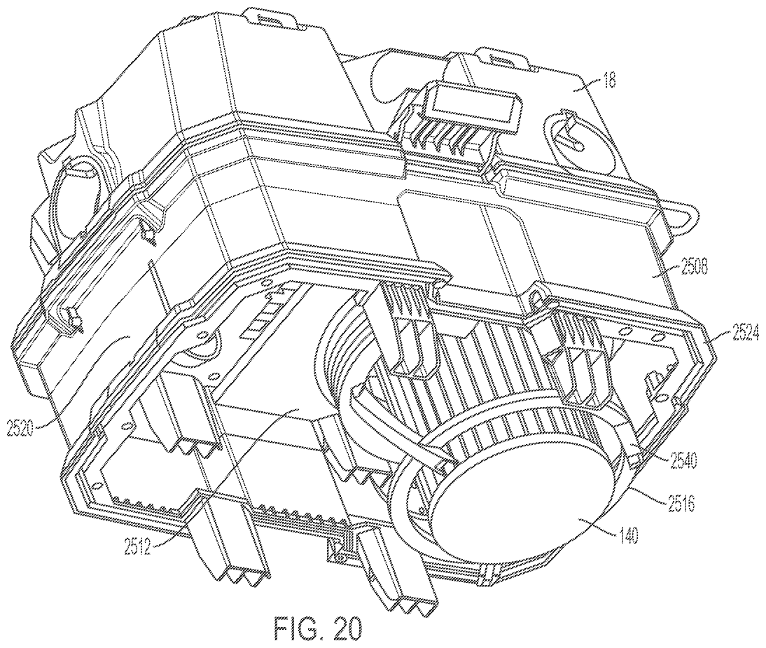

As shown in FIGS. 19 and 20, the cleaning assembly 2516 of the filter cleaner 2500 is supported within the working volume 2532 by the internal frame 2512 and is configured to selectively engage the filter 140 in such a manner that it dislodges or otherwise removes at least a portion of any dust and debris contained within the filter 140. Furthermore, the filter cleaner 2500 is configured so that it can selectively engage and clean the filter 140 without having to open or otherwise unseal the working volume 2532 (e.g., disassemble any the three elements 18, 22, 2500, or open any access points into the working volume 2532).

In the illustrated embodiment, the cleaning assembly 2516 includes a cage 2540 rotatably mounted to the internal frame 2512, one or more cleaning elements 2504 mounted to the cage 2540 and movable together therewith, and an actuator 2544. The cage 2540 of the cleaning assembly 2516 includes a series of structural members 2548 connected together to form a generally annular shape defining a cleaning channel 2550 therethrough. More specifically, the illustrated cage 2540 is sized so that the filter 140 may be at least partially positioned within the cleaning channel 2550. As shown in FIG. 20, the cage 2540 is made using a minimum number of members 2548 to assure the cage 2540 does not overly restrict the ability of air to flow into and through the filter 140 during use. In the illustrated embodiment, the cage 2540 includes a plurality of helical members 2548a and two hoop members 2548b positioning the helical member 2548 equally about the circumference of the cleaning channel 2550.

The cleaning elements 2504 of the cleaning assembly 2516 generally include a set of brushes whose bristles are configured to engage and dislodge dust and debris contained in any exposed elements of the filter 140. In the illustrated embodiment, the cleaning elements 2504 are mounted to the helical members 2548 so that they will circumferentially travel along and physically engage the exterior of the filter 140 during use. While the illustrated cleaning elements 2504 are brushes, it is understood that alternative forms of cleaning may also be used in place of or to supplement the brushes. For example, in some embodiments flexible blades or squeegees may be used. In still other embodiments, UV lights may also be used to disinfect the filter 140 during the cleaning process.

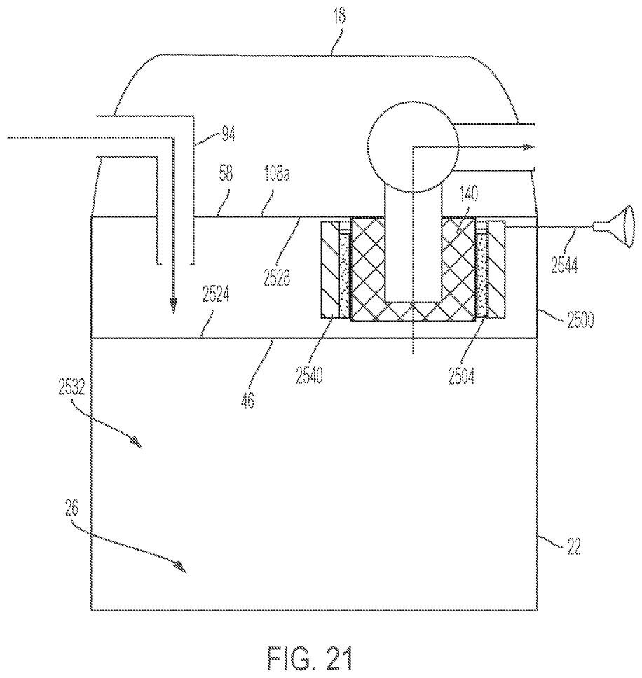

As shown in FIG. 21, the actuator 2544 is coupled to the cage 2540 and configured to rotate the cage 2540 with respect to the filter 140. In the illustrated embodiment, the actuator 2544 includes a pull cord 2552 that is wrapped about a hoop member 2548b of the cage 2540 before passing through an aperture 2556 formed in the housing 2508. The actuator 2544 then terminates with a handle 2660 that is accessible from outside the working volume 2532 without having to open or otherwise access the working volume 2532 directly. During operation, the user pulls the handle 2660 outwardly away from the vacuum causing the cable to unwind from the hoop member 2548b and the cage 2540 to rotate.

While the illustrated actuator 2544 is illustrated as a manual pull cord 2552, it is understood that in other embodiments the actuator 2544 may include an electrical motor configured to engage and rotate the cage 2540 relative to the filter 140. In still other embodiments, other forms of propulsion may be included. For example, the actuator 2544 may include operable connections to the head unit 18 so that the power systems contained therein (e.g., the battery packs, blower motor, and the like) may drive the system.

While the illustrated cleaning assembly 2516 includes a rotatable cage 2540, it is understood that additional forms of cleaning may also be included in the filter cleaner 2500 to supplement or in place of the rotatable cage 2540. Such forms of cleaning may include but are not limited to vibratory apparatus and the like.

To use the filter cleaner 2500, the user first couples the cleaner 2500 to the collection container 22. To do so, the user aligns and engages the first connection interface 46 of the container 22 with the first end 2524 of the perimeter wall 2520. The two elements 2500, 22 May then be secured via the coupling element 62.

With the cleaner 2500 coupled to the container 22, the user may then couple the head unit 18 to the cleaner 2500. To do so, the user aligns and engages the second connection interface 58 of the head unit 18 with the second end 2528 of the perimeter wall 2520 to completely enclose the working volume 2532 therebetween. When doing so, the user also aligns and inserts the filter 140 into the cleaning channel 2550 of the cleaning assembly 2516 so that the cage 2540 at least partially encompasses and axially overlaps with the circumferential exterior of the filter 140. Once in place, the filter 140, inlet passage 94, and cleaning assembly 2516 are all in fluid communication with the working volume 2532.

With the head unit 18, container 22, and filter cleaner 2500 assembled, the user may then proceed with using the vacuum for dust collection. Specifically, the user can activate the blower assembly 90 which, in turn, will draw untreated air into the working volume 2532 via the inlet passage 94. Once in the working volume 2532, dust and debris will collect in the collection volume 26 of the container 22. As the treated air is subsequently exhausted from the working volume 2532 via the filter 140, any remaining dust and debris will ultimately collect and become lodged within the filter 140 itself.

After period of operating the vacuum as described above, the user may then proceed with cleaning the filter 140. To do so, the user grasps the handle 2660 and pulls it away from the vacuum—not having to access or otherwise open the working volume 2532. When doing so, the cord 2552 uncoils from the cage 2540 causing it to rotate in a first direction with respect to the filter 140 about the filter axis 2536. By doing so, the cleaning elements 2504 attached to the cage 2540 engage with and are drawn over the exterior of the filter 140 dislodging any dust or debris contained therein. The dislodged dust and debris then settles into the collection volume 26. The user may then move the handle 2660 toward the vacuum where a spring or other biasing member 2664 will cause the cage 2540 to rotate in a second direction, opposite the first direction, to recoil the cord 2552 about the cage 2540 and reset the system. The user can then repeat this process (e.g., alternatingly moving the handle 2660 away and toward the vacuum) until the filter 140 is sufficiently clean. Once complete, the vacuum can return to dust collection operations as discussed above.

FIG. 22 illustrates another embodiment of the filter cleaner 3500. The filter cleaner 3500 is substantially the same as the filter cleaner 2500 discussed above so only the differences will be described in detail herein. The filter cleaner 3500 includes a frame 3512 that is configured to rest within and be supported by the container 22. More specifically, the frame 3512 has a size and shape that will allow the frame 3512 to be supported within the collection volume 26 and positioned proximate the open end 42 thereof. As discussed above, the cleaning assembly 3516 is supported within the working volume 3532 by the frame 3512 and is configured to selectively engage the filter 140.

To assemble the filter cleaner 3500, the use first positions the filter cleaner 3500 within the collection volume 26 of the container 22 such that the frame 3512 engages and is supported by the body 30 of the container 22 proximate the open end 42 thereof.

Once in place the user may then couple the head unit 18 to the container 22 directly. To do so, the user aligns and engages the second connection interface 58 of the head unit 18 with the first connection interface 46 of the container 22 to enclose the working volume 3532 therebetween (e.g., the head unit 18 and the container 22 at least partially define the working volume 3532). When doing so, the user also aligns and inserts the filter 140 into the cleaning channel 3550 of the cleaning assembly 3516. Once in place, the filter 140, inlet passage 94, collection chamber 26, and cleaning assembly 3516 are all in fluid communication with the working volume 3532. Finally, the pull cord 3552 may be fed through an aperture formed in one of the head unit 18 and the container 22 so the handle 3660 may be accessed from outside the working volume 3532 without having to open or otherwise access the volume 3532.

With the vacuum assembled, the vacuum may then be used for dust collection and filter cleaning operations as discussed above.

FIG. 23 illustrates another embodiment of the filter cleaner 4500. The filter cleaner 4500 is substantially the same as the filter cleaner 2500 discussed above so only the differences will be described in detail herein. The filter cleaner 4500 includes a frame 4512 that is fixedly coupled to the base wall 108a of the power head 18. As discussed above, the cleaning assembly 4516 is supported within the working volume 4532 by the frame 4512 and is configured to selectively engage the filter 140.

To assemble the filter cleaner 4500, the user first couples the frame 4512 to the base wall 108a of the head unit 18. When doing so, the user first positions the frame 4512 so that the filter 140 is at least partially positioned within the cleaning channel 4550 of the cleaning assembly 4516. Once properly positioned, the user may then secure the frame 4512 to the base wall 108a using fasteners, adhesives, and the like. The user may then feed the pull cord 4552 through an aperture formed in the head unit 18 so that the handle 4660 may be accessed from outside the working volume 4532 without having to open or otherwise access the volume 4532.

With the frame 4512 installed, the user may then couple the head unit 18 to the container 22 directly. To do so, the user aligns and engages the second connection interface 58 of the head unit 18 with the first connection interface 46 of the container 22 to enclose the working volume 4532 therebetween (e.g., the head unit 18 and the container 22 at least partially define the working volume 4532). Once in place, the filter 140, inlet passage 94, collection chamber 34, and cleaning assembly 4516 are all in fluid communication with the working volume 4532.

With the vacuum assembled, the vacuum may then be used for dust collection and filter cleaning operations as discussed above.

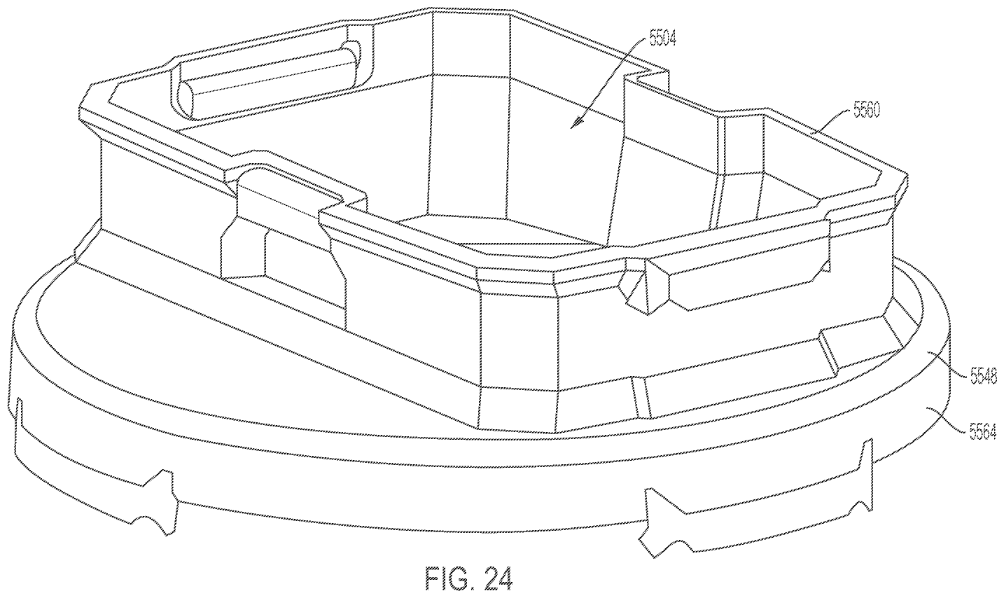

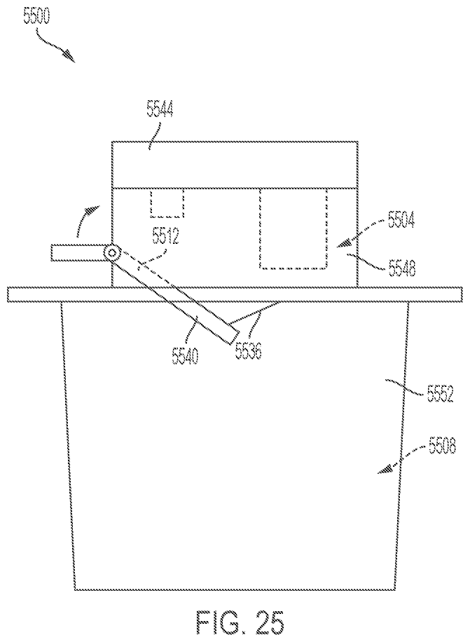

FIGS. 24-25 illustrate a multi-chamber vacuum assembly 5500. More specifically, the vacuum assembly 5500 includes a first or primary storage volume 5504 that is subject to the low-pressure forces generated by a vacuum blower assembly 5516, and a second or secondary storage volume 5508 that is may be fluidly isolated from the low-pressure forces generated by the blower assembly 5516. The assembly 5500 further includes a valve or gate 5512 to allow any contents collected within the first storage volume 5504 to be deposited within the second storage volume 5508 without having to open or otherwise access either storage volume 5504, 5508.

The illustrated vacuum assembly 5500 includes a blower assembly 5516, an air inlet 5520, a first or primary storage volume 5504, a second or secondary storage volume 5508, and a gate or valve 5512 in fluid communication with both the first storage volume 5504 and the second storage volume 5508. The blower assembly 5516, in turn, includes a blower inlet 5524 and a blower outlet 5528. During use, the blower assembly 5516 may be activated (e.g., placed in an activated configuration) whereby an internal impeller (not shown) rotates causing air to be drawn into the blower inlet 5524 and discharged via the blower outlet 5528. By doing so, the blower assembly 5516 generates a relatively low-pressure zone or region 5532 at the blower inlet 5524 when in the activated configuration.

The air inlet 5520 of the vacuum assembly 5500 includes a fluid passage or channel configured to receive untreated air from a hose or other vacuum accessory and convey the untreated air to the first storage volume 5504. More specifically, the air inlet 5520 includes a first end 5566 that is open to the exterior of the vacuum to serve as a mounting point to which a hose or other vacuum accessory (not shown) may be releasably attached during use. The air inlet 5520 also includes a second end 5568 opposite the first end 5566 that terminates in fluid communication with the first storage volume 5504.

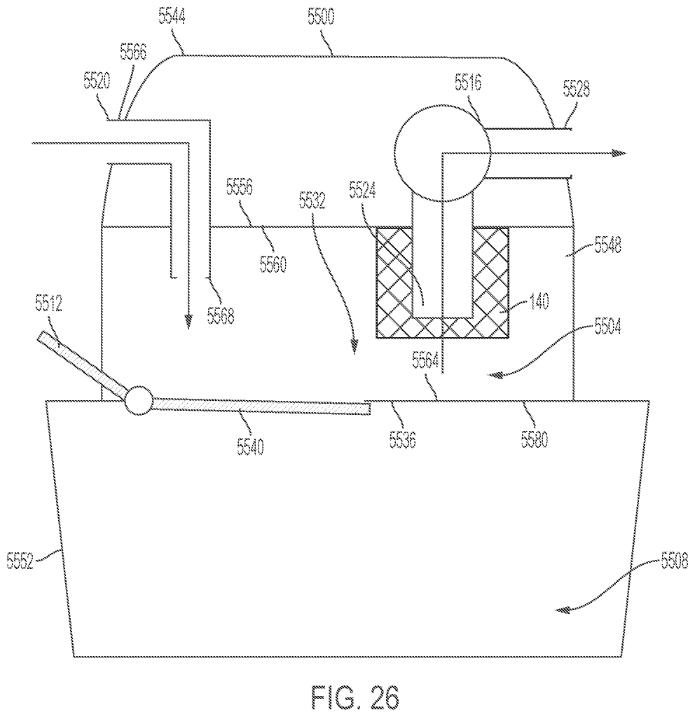

The first storage volume 5504 is configured to collect dust and debris separated from the untreated air collected via the air inlet 5520 before the treated air is filtered and discharged via the blower assembly 5516 (see FIG. 26). More specifically, the first storage volume 5504 is in fluid communication with both the second end 5568 of the air inlet 5520 and the blower inlet 5524. During use, activation of the blower assembly 5516 generates a relatively low-pressure region at the blower inlet 5524 and, as a result, within the first storage volume 5504 generally. This relatively low-pressure region then draws the untreated air into the first storage volume 5504 via the air inlet 5520. Due to the relatively low-pressure region generated generally within the first storage volume 5504, the enclosure and walls defining the first storage volume are generally reinforced or strengthened to withstand the forces present.

The second storage volume 5508 is configured to receive and collect dust and debris originally deposited within the first storage volume 5504. More specifically, after the vacuum process is complete and the relatively low-pressure region within the first storage volume 5504 dissipated, the second storage volume 5508 may be placed in fluid communication with and receive collected dust and debris from the first storage volume. As such, the second storage volume 5508 is not intended to be exposed to the generally low pressures generated by the blower assembly 5516. Because of this, the walls and enclosures defining the second storage volume 5508 do not need to be as strong as those forming the first storage volume 5504. Because the strength requirements are reduced, the second storage volume 5508 may be formed at least partially be pre-existing storage containers such as, but not limited to, trash cans, storage crates, plastic tubs, and the like.

The valve 5512 of the assembly 5500 is in fluid communication with both the first storage volume 5504 and the second storage volume 5508 and is configured to selectively control the flow of fluids and material therebetween. More specifically, the valve 5512 is adjustable between a first or closed configuration, in which the first storage volume 5504 is not in fluid communication with the second storage volume 5508 (e.g., the two volumes are fluidly isolated from each other), and a second or open configuration, in which the first storage volume 5504 is open to and in fluid communication with the second storage volume 5508. During use, the valve 5512 is generally configured so that it remains in the closed configuration when the blower assembly 5516 is activated and then can be opened (either automatically or manually) when the blower assembly 5516 is deactivated.

The valve 5512 includes a seat 5536 and a flapper or gate 5540 movable with respect to the seat 5536. In the illustrated embodiment, the gate 5540 and seat 5536 are configured so that the gate 5540 is biased into engagement with the seat 5536 when there is a relatively low-pressure zone in the first storage volume 5504 (e.g., relative to the second storage volume 5508). In still other embodiments, the valve 5512 may also include a biasing member or spring to actively bias the gate 5540 into engagement with the seat 5536. In still other embodiments, the gate 5540 may be balance and configured such that it is biased into engagement with the seat 5536 (e.g., into a closed configuration) when there is a relatively low pressure zone in the first storage volume 5504, and be biased out of engagement with the seat 5536 (e.g., into an open configuration) when there is no low pressure zone present in the first storage volume 5504.

As shown in FIG. 25, the vacuum assembly 5500 is formed from multiple detachable housings 5544, 5548, 5552. More specifically, the vacuum assembly 5500 includes a first housing or head unit 5544 that generally includes the blower assembly 5516 and air inlet 5520 formed therein. The first housing 5544, in turn, also defines a first connection interface 5556.

The assembly 5500 also includes a second housing or adapter 5548. In the illustrated embodiment, the adapter 5548 at least partially defines the first storage volume 5504, at least partially forms the seat 5536 of the valve 5512, and movably supports the gate 5540 of the valve 5512. The adapter 5548 may also at least partially define a portion of the second storage volume 5508.

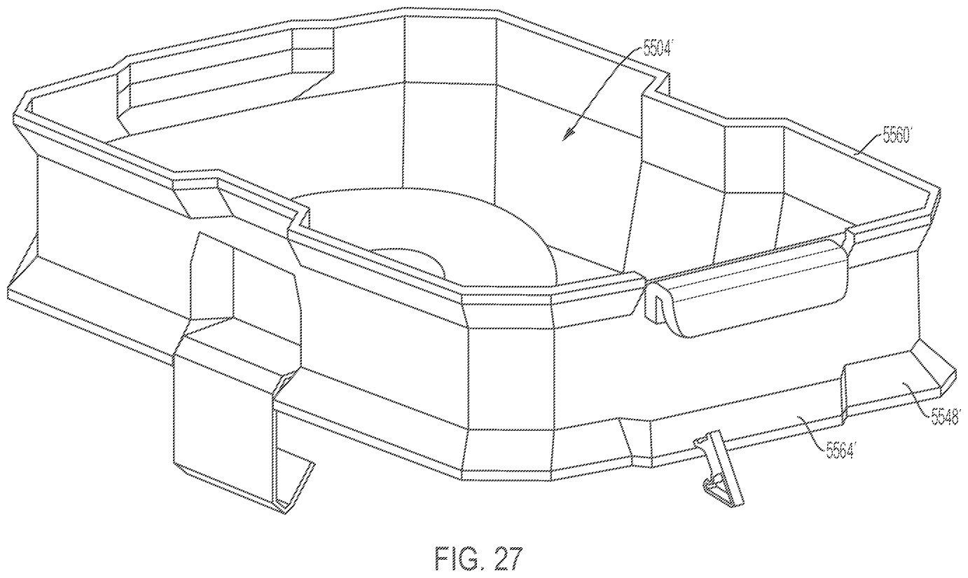

The adapter 5548 also forms a second connection interface 5560 generally corresponding to the size and shape of the first connection interface 5556 of the first housing 5544, and a third connection interface 5564. In the illustrated embodiment, the second connection interface 5564 may be configured for attachment to a third-party container such as, but not limited to a garbage can, a storage container, and the like. For example, FIG. 24 illustrates a second housing 5548 with a third connection interface 5564 configured to attachment to a garbage can having a substantially circular open end. Furthermore, FIG. 27 illustrates another embodiment of a second housing 5548′ with a third connection interface 5564′ that is configured for attachment to a storage crate having a substantially rectangular open end. It is understood that still more embodiments may be present to allow for adapters 5548 that can be attached to other forms of container.

The third housing 5552 of the assembly 5500 at least partially defines the second storage volume 5508 and includes a fourth connection interface 5580. In the illustrated embodiment, the third housing 5552 includes a third-party container that is not reinforced nor capable of withstanding the relatively low-pressure zone generated by the blower assembly 5516. In some embodiments, the third housing 5552 may include a garbage can, a plastic storage container, plastic garbage bag, fabric sack, and the like. Specifically, because the valve 5512 and first storage volume 5504 (e.g., the adapter 5548) shield the third housing 5552 from the forces present during the vacuuming process, the third housing 5552 need not have the ability to withstand negative pressure at all. Rather, the third housing 5552 can be a relatively inexpensive container for bulk collection of dirt and debris.

To operate the vacuum assembly 5500, the user first attaches the adapter 5548 to a select third housing 5552 (e.g., third party or otherwise disposable container). To do so, the user aligns and connects the third connection interface 5564 with the fourth connection interface 5580 of the third housing 5552. The adapter 5548 and the third housing 5552 then at least partially define the second storage volume 5508 therebetween.

With the third housing 5552 connected, the user may then install the power head 5544. To do so, the user aligns and connects the first connection interface 5556 of the power head 5544 with the second connection interface 5560 of the adapter 5548. When doing so, the blower inlet 5524 and second end 5568 of the air inlet 5520 are placed in fluid communication with the first storage volume 5504.

With the assembly connected 5500, the user may then place the assembly 5500 in the first or vacuuming configuration. To do so, the user places the valve 5512 in the closed configuration and activates the blower assembly 5516. As described above, activation of the blower assembly 5516 generates a relatively low-pressure region 5532 at the blower inlet 5524 and in the first storage volume 5504 generally. The resulting low-pressure region 5532 then draws untreated air into the first storage volume 5504 via the air inlet 5520 where dust and debris are deposited therein. The treated air then exits the first storage volume 5504 via the blower inlet 5524.

When the first storage volume 5504 becomes full of dust and debris, the user may then place the assembly 5500 in a dump or transfer configuration. To do so, the blower assembly 5516 is deactivated—eliminating the lower pressure region 5532 within the first storage volume 5504—and the valve 5512 is placed in an open configuration. With the valve 5512 open, all dust and debris within the first storage volume 5504 may transfer (e.g., fall under the force of gravity) into the second storage volume 5508. Once the first storage volume 5504 is empty, the valve 5512 may then be re-closed (e.g., switched back to the closed configuration) and the vacuuming process continued.

What is claimed is:

1. A vacuum pre-separation device for use with a vacuum assembly having a power head and a collection container, the pre-separation device comprising:
a housing defining a housing volume, wherein the housing includes a first connection interface configured to attach to the power head and a second connection interface configured to attach to the collection container;
a cyclonic separator at least partially positioned within the housing volume, wherein the cyclonic separator includes a discharge port open to the second connection interface; and
a feed passage configured to direct air into the cyclonic separator, wherein a first end of the feed passage is open to the first connection interface.

2. The vacuum pre-separation device of claim 1, wherein the first connection interface encloses a first connection region, wherein the first end of the feed passage is positioned within the first connection region.

3. The vacuum pre-separation device of claim 1, wherein the first connection interface and the second connection interface are positioned on opposite sides of the housing.

4. The vacuum pre-separation device of claim 1, wherein the cyclonic separator includes an exit aperture, and wherein the exit aperture is in fluid communication with the first connection interface.

5. The vacuum pre-separation device of claim 4, further comprising a filter casing sized to receive at least a portion of an air filter therein, and wherein the pre-separation device further includes an intermediate passage extending between the exit aperture and the filter casing.

6. The vacuum pre-separation device of claim 1, further comprising a filter casing sized to receive at least a portion of an air filter therein, and wherein the filter casing is open to the first connection interface.

7. The vacuum pre-separation device of claim 6, wherein the first connection interface encloses a first connection region, wherein the filter casing includes an open end, and wherein the open end is positioned within the first connection region.

8. The vacuum pre-separation device of claim 1, further comprising a first set of connection implements configured to selectively couple the housing to the collection container.

9. The vacuum pre-separation device of claim 8, further comprising a second set of connection implements configured to selectively couple the housing to the power head.

10. The vacuum pre-separation device of claim 1, wherein the housing includes a perimeter wall at least partially encompassing the housing volume, wherein the perimeter wall includes a first end and a second end opposite the first end, wherein the first end defines the first mounting interface, and wherein the second end defines the second mounting interface.

11. A vacuum assembly comprising:
a power head, wherein the power head includes:
a first housing at least partially defining a power head volume,
a blower assembly at least partially positioned within the power head volume;
a collection container at least partially defining a collection volume; and
a pre-separator unit, wherein the pre-separator includes:
a second housing at least partially defining a pre-separator volume,
a cyclonic separator at least partially positioned within the pre-separator volume, and
a first flow path extending between the cyclonic separator and the blower assembly, and wherein the first flow path is always positioned within at least one of the power head volume and the pre-separator volume.

12. The vacuum assembly of claim 11, wherein the power head further includes an inlet port open to the exterior of the first housing, the vacuum assembly further comprising a second flow path extending between the inlet port and the cyclonic separator, wherein the second flow path is always positioned within at least one of the first power head volume and the pre-separator volume.

13. The vacuum assembly of claim 11, wherein the cyclonic separator includes a discharge port, and wherein the discharge port is in fluid communication with the collection volume.

14. The vacuum assembly of claim 13, further comprising a debris flow path extending between the discharge port and the collection volume, and wherein the debris flow path is always positioned within at least one of the pre-separator volume and the collection volume.

15. The vacuum assembly of claim 11, wherein the first flow path passes through a filter.

16. A vacuum assembly comprising:
a power head comprising:
a first housing at least partially defining a power head volume, wherein the first housing defines a first connection interface including a first internal connection region, and
a blower assembly at least partially positioned within the power head volume; and
a pre-separator unit comprising:
a second housing at least partially defining a pre-separator volume, wherein the second housing defines a second connection interface including a second connection region, and
a cyclonic separator at least partially positioned within the pre-separator volume; and
a first flow path extending between the cyclonic separator and the blower assembly, and wherein the first flow path passes through both the first internal connection region and the second internal connection region.

17. The vacuum assembly of claim 16, wherein the power head also includes an inlet port that is open to the outside of the first housing, the vacuum assembly further comprising a second flow path extending between the inlet port and the cyclonic separator, and wherein the second flow path passes through both the first internal connection region and the second internal connection region.

18. The vacuum assembly of claim 16, wherein the pre-separator unit includes a filter casing configured to contain a filter therein, and wherein the filter is attached to the power head.

19. The vacuum assembly of claim 16, wherein the first flow path passes through a filter.

20. The vacuum assembly of claim 16, wherein the first connection interface interacts with the second connection interface to relatively align the power head with the pre-separator unit.

21. A vacuum assembly comprising:
a power head including a blower assembly, and a filter assembly;
a collection container coupled to the power head, wherein together the collection container and the power head at least partially define a working volume therebetween, and wherein the filter assembly is in fluid communication with the working volume; and
a cleaning assembly, wherein the cleaning assembly is configured to selectively engage the filter assembly to dislodge at least a portion of the dust and debris contained therein.

22. The vacuum assembly of claim 21, wherein the cleaning assembly is at least partially positioned within the working volume.

23. The vacuum assembly of claim 21, wherein the cleaning assembly also includes a housing, and wherein the housing at least partially defines the working volume.

24. The vacuum assembly of claim 23, wherein the housing includes a first connection interface configured to be releasably coupled to the power head, and a second connection interface configured to be releasably coupled to the collection container.

25. The vacuum assembly of claim 21, wherein the collection container is directly coupled to the power head.

26. The vacuum assembly of claim 21, wherein the filter assembly defines a filter axis, and wherein the cleaning assembly includes a cage that rotates with respect to the filter assembly about the filter axis.

27. The vacuum assembly of claim 21, wherein the cleaning assembly is configured to selectively engage the filter assembly to dislodge at least a portion of the dust and debris contained therein without having to open to working volume.

28. A vacuum assembly comprising;
an air inlet through which untreated air may be collected;
a blower assembly having a blower inlet and a blower outlet;
a first storage volume in fluid communication with the air inlet and the blower inlet;
a second storage volume; and
a valve extending between and in fluid communication with both the first storage volume and the second storage volume, where the valve is adjustable between a first condition, in which the first storage volume is in fluid communication with the second storage volume, and a second condition, in which the second storage volume is not in fluid communication with the second storage volume.

29. The vacuum assembly of claim 28, wherein the vacuum is operable in a first operating condition, in which the blower assembly is activated and the valve is in the second condition, and the vacuum is operable in a second operating condition, in which the blower assembly is not activated and the valve is in the first condition.

30. The vacuum assembly of claim 29, wherein the blower assembly is configured to generate a zone of low pressure within the first storage volume when it is activated.

31. The vacuum assembly of claim 29, further comprising:
a first housing containing the blower assembly therein;
a second housing removably coupled to the first housing, wherein the second housing at least partially defines the first storage volume; and
a third housing removably coupled to the second housing, wherein the third housing at least partially defines the second storage volume.

32. The vacuum assembly of claim 31, wherein the first housing at least partially defines the first storage volume.

33. The vacuum assembly of claim 31, wherein the second housing at least partially defines the second storage volume.

34. The vacuum assembly of claim 28, wherein the valve is biased toward the second condition.

35. The vacuum assembly of claim 28, wherein the valve includes a valve seat and a valve actuator movable into and out of engagement with the valve seat, and wherein the presence of a low-pressure zone within the first storage volume biases the valve actuator into engagement with the valve seat.
